(19) United States
(12) Patent Application Publication
(10) Pub. No.: US 2019/0034945 A1
(43) Pub. Date: Jan. 31, 2019

(54) INFORMATION PROCESSING SYSTEM, INFORMATION PROCESSING METHOD, AND INFORMATION PROCESSING PROGRAM

(71) Applicant: NEC CORPORATION, Tokyo (JP)

(72) Inventors: Yousuke MOTOHASHI, Tokyo (JP); Keisuke UMEZU, Tokyo (JP)

(73) Assignee: NEC CORPORATION, Tokyo (JP)

(21) Appl. No.: 16/070,956

(22) PCT Filed: Mar. 25, 2016
(86) PCT No.: PCT/JP2016/001751

§ 371 Date: Jul. 18, 2018

(51) Int. Cl. G06Q 30/02; G06N 99/00; G06F 17/18

(52) U.S. Cl. CPC G06Q 30/0202; G06F 17/18; G06N 99/005

(57) ABSTRACT

An information processing system 80 configured to predict a prediction target specified by a plurality of classifications using a prediction model including a variable that affects the prediction target, includes an accepting unit 81 and an aggregating unit 82. The accepting unit 81 accepts classifications that specify the prediction target. The aggregating unit 82 specifies the prediction target by the accepted classifications and aggregates, for each of the variables, a degree of contribution determined by the prediction model corresponding to that prediction target.

### TECHNICAL FIELD

The present invention relates to an information processing system, an information processing method, and an information processing program that analyze a factor that can contribute to a prediction target.

### BACKGROUND ART

A method of conducting various analyses based on a large amount of performance data is known. Point of sale (POS) data is an example of data representing the sales performance of each store. For example, in a case where a company developing 1000 retail stores nationwide aggregates the sales volume of 2000 types of commodities per store per month, the number of such POS data in one year sums up to 1000 (stores)×12 (months/year)×2000 (types/month and store)=24,000,000.

As a method of analyzing such POS data, for example, there is a method of using an aggregation tool having a function such as a pivot table of EXCEL (registered trademark). By causing such an aggregation tool to read the POS data, it is possible for a user to aggregate the number of sales of commodities from various viewpoints, such as for each store, for each season, and for each commodity and to freely analyze a factor that has contributed to the sales from a micro viewpoint to a macro viewpoint.

Besides, tableau (registered trademark), Statistical Analysis System (SAS) (registered trademark), Statistical Package for Social Science (SPSS) (registered trademark), and the like are known as examples of such software specialized for statistics.

In addition, PTL 1 describes a system that aggregates unspecified majority of people using a plurality of pieces of data. The system described in PTL 1 acquires data on the number of visitors by counting visitors to a predetermined place based on input data and also acquires characteristic estimation data by estimating characteristics of visitors based on input data.

### CITATION LIST

### Patent Literature

PTL 1: International Publication WO2009/041242

### SUMMARY OF INVENTION

### Technical Problem

According to the technique described in PTL 1, it is possible to count the number of visitors to a predetermined place based on input data. However, the technique described in PTL 1 does not consider analyzing what kind of factors contributed to the number of visitors to what extent with respect to the number of visitors to a predetermined place.

Accordingly, an object of the present invention is to provide an information processing system, an information processing method, and an information processing program capable of analyzing a factor that can contribute to a prediction target.

### Solution to Problem

An information processing system according to the present invention is an information processing system configured to predict a prediction target specified by a plurality of classifications using a prediction model including a variable that affects the prediction target, the information processing system including: an accepting unit that accepts classifications that specify the prediction target; and an aggregating unit that specifies the prediction target by the accepted classifications and aggregates, for each of the variables, the degree of contribution determined by the prediction model corresponding to the prediction target.

An information processing method according to the present invention is an information processing method configured to predict a prediction target specified by a plurality of classifications using a prediction model including a variable that affects the prediction target, the information processing method including: accepting classifications that specify the prediction target; and specifying the prediction target by the accepted classifications and aggregating, for each of the variables, the degree of contribution determined by the prediction model corresponding to the prediction target.

An information processing program according to the present invention is an information processing program applied to a computer configured to predict a prediction target specified by a plurality of classifications using a prediction model including a variable that affects the prediction target, the information processing program causing the computer to execute: an accepting process of accepting classifications that specify the prediction target; and an aggregating process of specifying the prediction target by the accepted classifications and aggregating, for each of the variables, the degree of contribution determined by the prediction model corresponding to the prediction target.

### Advantageous Effects of Invention

According to the present invention, it is possible to analyze a factor that can contribute to a prediction target.

### BRIEF DESCRIPTION OF DRAWINGS

FIG. 1 It depicts a block diagram illustrating a configuration example of a first exemplary embodiment of an information processing system according to the present invention.

FIG. 2 It depicts an explanatory diagram illustrating an example of storing prediction targets and a plurality of classifications in association with each other.

FIG. 3 It depicts an explanatory diagram illustrating an example of explanatory variables.

FIG. 4 It depicts an explanatory diagram illustrating an example of prediction models for prediction targets.

FIG. 5 It depicts an explanatory diagram illustrating a specific example of actually measured values of an explanatory variable.

FIG. 6 It depicts an explanatory diagram illustrating an example of a process of specifying a prediction target.

FIG. 7 It depicts an explanatory diagram illustrating an example of a process of calculating the total sums of weights of explanatory variables.

FIG. 8 It depicts a flowchart illustrating an action example of the information processing system of the first exemplary embodiment.

FIG. 9 It depicts a flowchart illustrating an example of an action of specifying a prediction model to be aggregated.

FIG. 10 It depicts an explanatory diagram illustrating an example of a process of calculating a total sum of products calculated for each explanatory variable.

FIG. 11 It depicts a flowchart illustrating an action example of an information processing system of a second exemplary embodiment.

FIG. 12 It depicts an explanatory diagram illustrating an example of a process of analyzing a factor using a plurality of prediction models.

FIG. 13 It depicts an explanatory diagram illustrating an example of explanatory variables in which categories are set.

FIG. 14 It depicts a flowchart illustrating an action example of an information processing system of a third exemplary embodiment.

FIG. 15 It depicts an explanatory diagram illustrating an example in a case where the degrees of contribution are aggregated for each category.

FIG. 16 It depicts an explanatory diagram illustrating an example of a conditional predictor.

FIG. 17 It depicts an explanatory diagram illustrating an example of an aggregation screen.

FIG. 18 It depicts an explanatory diagram illustrating an example of information included in a drop-down list.

FIG. 19 It depicts an explanatory diagram illustrating an example of a result of outputting factors contributing to a prediction target.

FIG. 20 It depicts an explanatory diagram illustrating another example of a result of outputting factors contributing to a prediction target.

FIG. 21 It depicts an explanatory diagram illustrating an example of a result of outputting categories contributing to a prediction target.

FIG. 22 It depicts an explanatory diagram illustrating another example of a result of outputting categories contributing to a prediction target.

FIG. 23 It depicts an explanatory diagram illustrating an example of outputting aggregation results of both of an upper classification and a lower classification.

FIG. 24 It depicts an explanatory diagram illustrating another example of prediction models for prediction targets.

FIG. 25 It depicts an explanatory diagram illustrating an example in which weights of prediction targets for each category are represented in a table format.

FIG. 26 It depicts an explanatory diagram illustrating an example of outputting aggregation results in a heat map format.

FIG. 27 It depicts an explanatory diagram illustrating an example of outputting aggregation results as a balance chart.

FIG. 28 It depicts an explanatory diagram illustrating an example of visualizing the ratio of the degree of contribution of each explanatory variable.

FIG. 29 It depicts an explanatory diagram illustrating an example of outputting the degrees of contribution of explanatory variables belonging to a category.

FIG. 30 It depicts an explanatory diagram illustrating an example in which prediction targets are changed.

FIG. 31 It depicts an explanatory diagram illustrating another example in which prediction targets are changed.

FIG. 32 It depicts a block diagram illustrating the outline of the information processing system according to the present invention.

### DESCRIPTION OF EMBODIMENTS

As described in PTL 1, it is common to use a large amount of past performance data in analyzing information. Meanwhile, in analyzing information, it is also conceivable to use prediction models learned for each prediction target based on past performance data as well as past performance data itself. It is considered that the prediction model properly learned based on the performance data appropriately reflects the properties of the performance data. Therefore, it becomes possible to analyze a factor that can contribute to a prediction target based on such a prediction model.

However, prediction models are generally used for predicting results and it is not usual to use large amounts of prediction models themselves for factor analysis. When a prediction model is learned for each prediction target, if there is a large amount of prediction targets, a large amount of prediction models also exists. The present inventors gained the idea of analyzing a factor that can contribute to the prediction target by aggregating a large amount of prediction models.

Hereinafter, exemplary embodiments of the present invention will be described with reference to the drawings. In the following description, it is assumed that each prediction target is predicted using a prediction model and the prediction model has already been learned with past performance data and the like in advance. In addition, one prediction model is associated with one prediction target.

The prediction model is information representing a correlation between an explanatory variable and an objective variable. The prediction model is, for example, a component for predicting a prediction target result by calculating a variable as an objective based on an explanatory variable. The prediction model is generated by a learning device using learning data for which a value of an objective variable has already been obtained and an arbitrary parameter as inputs. The prediction model may be represented by, for example, a function c that maps an input x to a correct solution y. The prediction model may predict a numerical value of the prediction target or may predict a label of the prediction target. The prediction model may output a variable describing a probability distribution of the objective variable. The prediction model may be denoted as “model”, “learning model”, “estimation model”, “prediction formula”, or “estimation formula”, for example.

In the present exemplary embodiment, the prediction model is represented by a prediction formula including one or more explanatory variables indicating factors that can contribute to the prediction result of the prediction target. In the prediction model, for example, the objective variable is represented by a linear regression equation including a plurality of explanatory variables. In the above example, the objective variable is equivalent to the correct solution y and the explanatory variable is equivalent to the input y. The maximum number of explanatory variables included in one prediction model may be restricted for the purpose of, for example, enhancing the interpretability of the prediction model and preventing over learning. As will be described later, the prediction formula used for predicting one prediction target is not limited to one and a conditional predictor in which the prediction formula is selected according to the value of the explanatory variable may be used as the prediction model.

The prediction target is assumed to belong to one or more classifications designated by a user. The classification may be singular or may have a hierarchical structure. Taking a retail store as an example, the prediction target is, for example, “the number of sales of orange juice sold at a shop A in Tokyo”. In this case, the prediction target is specified by the classification of a sales store (Tokyo>shop A) and the classification of a commodity (beverage>fruit juice beverage>orange juice). Here, the symbol denoted by “>” indicates that the classification is in a hierarchical structure.

Besides, the prediction target is, for example, “the number of sales of a ballpoint pen of Company A's private brand sold in March 2016 at a shop B managed by Company A”. In this case, the prediction target is specified by the classification of a sales store (managed by Company A>shop B), the classification of timing of sales (2016>March 2016), and the classification of a commodity (Company A's private brand>stationery>ballpoint pen).

### First Exemplary Embodiment

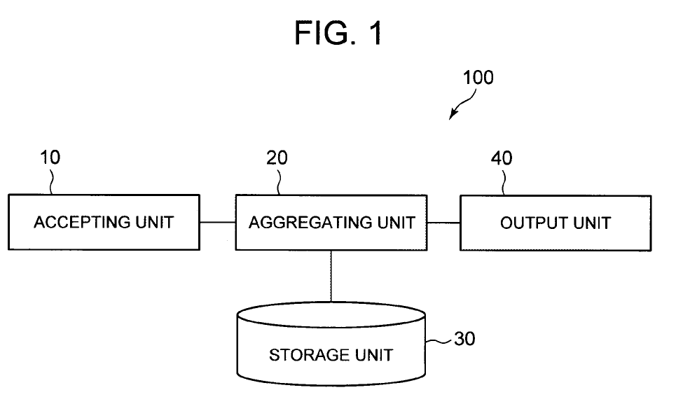

FIG. 1 is a block diagram illustrating a configuration example of a first exemplary embodiment of an information processing system according to the present invention. The information processing system 100 according to the present exemplary embodiment includes an accepting unit 10, an aggregating unit 20, a storage unit 30, and an output unit 40.

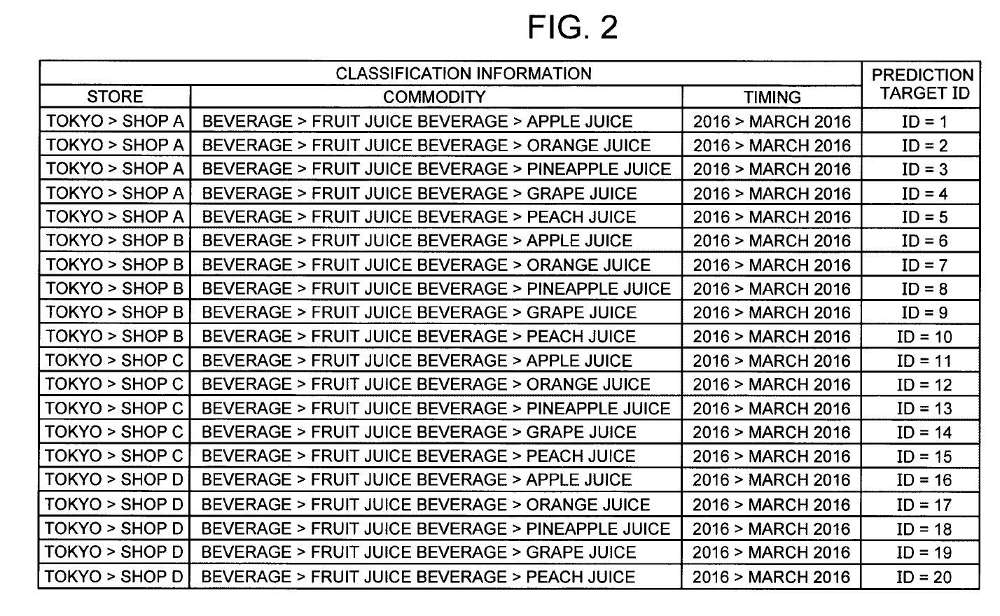

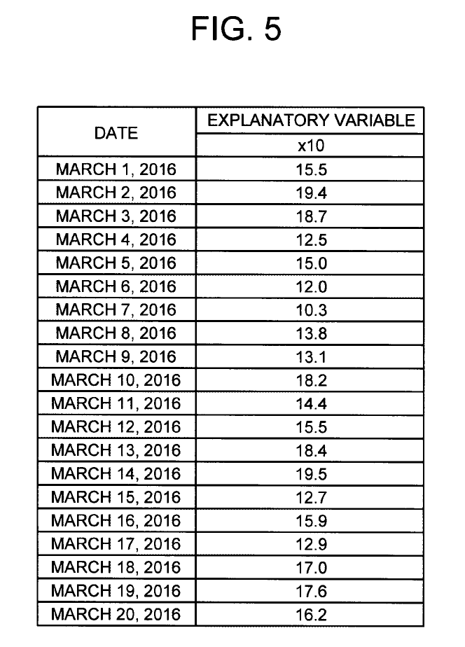

The storage unit 30 stores a prediction model for each prediction target. FIGS. 2 to 5 are explanatory diagrams illustrating examples of information stored in the storage unit 30. The storage unit 30 may store the prediction target and the classification in association with each other. In addition, the storage unit 30 may store an actually measured value of the explanatory variable. Here, the actually measured value of the explanatory variable means the value of each explanatory variable actually measured, as exemplified in FIG. 5, for example.

FIG. 2 illustrates an example in which the storage unit 30 stores prediction targets and a plurality of classifications in association with each other. The example illustrated in FIG. 2 indicates that the prediction target is uniquely identified by a prediction target ID and each of “store”, “commodity” and “timing” as the classifications is associated with the respective prediction target IDs. For example, it is indicated that a prediction target identified by a prediction target ID=1 is classified into the shop A in Tokyo from the viewpoint of “store”, is classified into apple juice which is a fruit juice beverage among beverages from the viewpoint of “commodity”, and is classified into March 2016 from the viewpoint of “timing”.

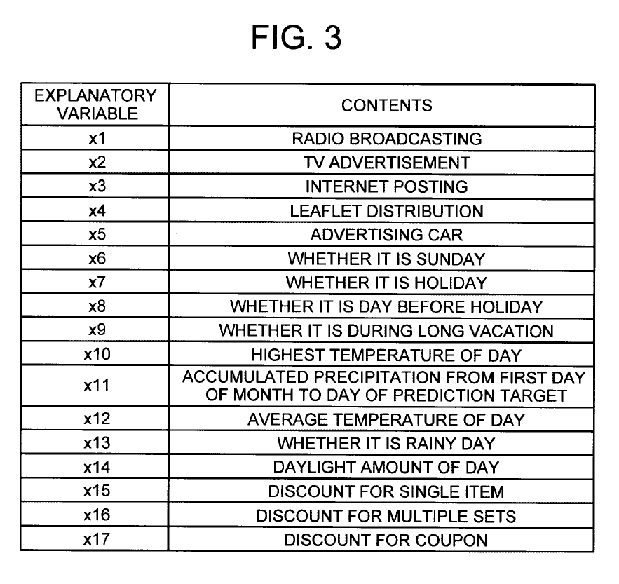

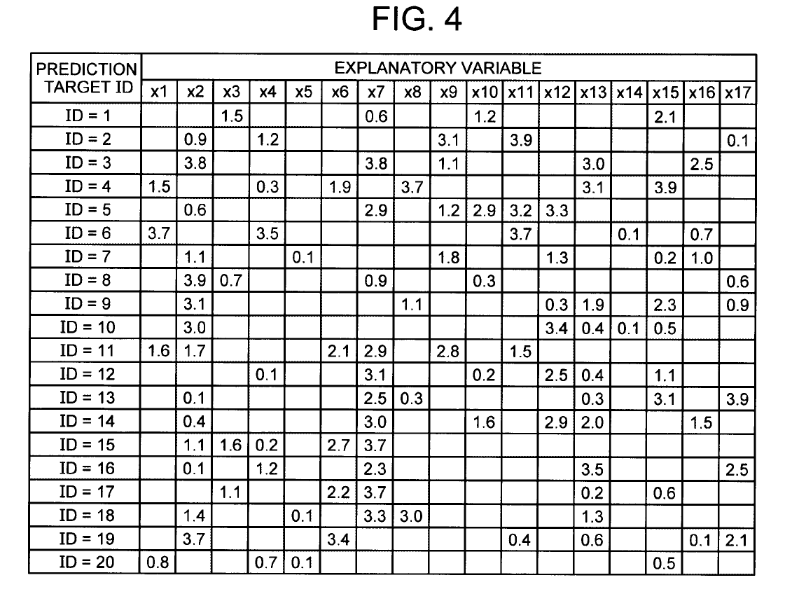

FIG. 3 illustrates an example of the explanatory variables. In addition, FIG. 4 illustrates an example in which the storage unit 30 stores prediction models for prediction targets. Here, it is assumed that the explanatory variables exemplified in FIG. 3 are used in the prediction models exemplified in FIG. 4.

In the example illustrated in FIG. 4, a vertical direction of the table indicates the prediction targets, whereas a horizontal direction of the table indicates weights of the explanatory variables representing the prediction models for these prediction targets. For example, it is indicated that a prediction model for the prediction target identified by the prediction target ID=1 is represented using explanatory variables x₃, x₇, x₁₀, and x₁₅ and their weights are 1.5, 0.6, 1.2, and 2.1, respectively. For example, when the prediction model is a linear regression equation, the prediction model for the prediction target identified by the prediction target ID=1 is y=1.5x₃+0.6x₇+1.2x₁₀+2.1x₁₅, where the objective variable is denoted by y. Note that it is assumed that the prediction models exemplified in FIG. 4 predict a commodity demand amount for each day and the prediction models (prediction formulas) are updated at the end of the month.

FIG. 5 illustrates a specific example of actually measured values of an explanatory variable. For example, in a case where the explanatory variable x₁₀ is a variable expressing “the highest temperature of the day”, the actually measured value exemplified in FIG. 5 is the value of the highest temperature of each day actually measured. When the aggregation periods of the actually measured value and the explanatory variable are different, the actually measured values may be aggregated according to a rule determined in advance such that the aggregation result is employed as the actually measured value of the explanatory variable. For example, when the explanatory variable is “the highest temperature in the month” and the actually measured value is “the highest temperature of each day”, the highest temperature within the month may be specified such that the specified value is employed as the actually measured value.

The storage unit 30 is implemented by, for example, a magnetic disk device. The output unit 40 outputs the aggregation result by the aggregating unit 20. The output unit 40 may also accept an input from the user for the output result. The output unit 40 is implemented by, for example, a display device or a touch panel.

The accepting unit 10 accepts a classification that specifies a prediction target. In other words, the accepting unit 10 accepts a classification for specifying a prediction target for which a factor is to be analyzed. The classification to be accepted is not limited to one, but may be plural. For example, when a factor for “apple juice” at each store in March 2016 is analyzed, the accepting unit 10 accepts “March 2016” and “apple juice” as classifications. In addition, when the classification is in a hierarchical structure, the accepting unit 10 may accept not only a lowest classification but also an upper classification. For example, the accepting unit 10 may cause the output unit 40 to display candidate classifications and accept one or more classifications selected by the user. Besides, the accepting unit 10 may accept a classification via a communication network.

The aggregating unit 20 specifies a prediction target based on the accepted classification and specifies a prediction model for the specified prediction target. Specifically, the aggregating unit 20 specifies a prediction model for the prediction target from within the storage unit 30.

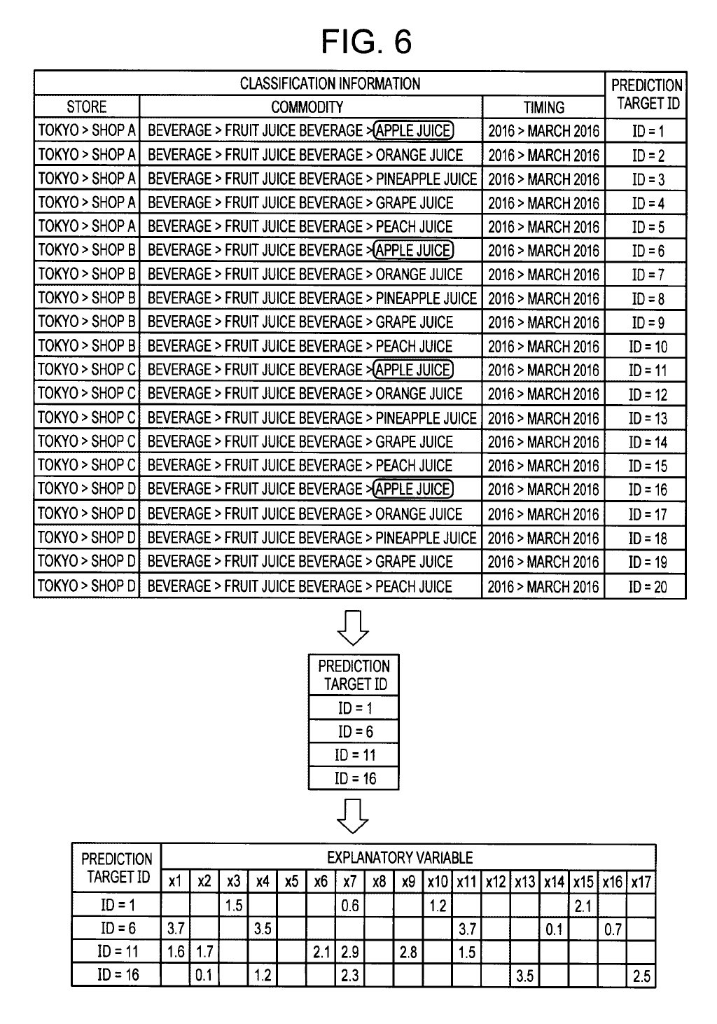

FIG. 6 is an explanatory diagram illustrating an example of a process of specifying a prediction target from the information exemplified in FIGS. 2 to 5 based on the accepted classifications. For example, assuming that a factor for “apple juice” at each store in March 2016 is analyzed, the accepting unit 10 accepts “March 2016” and “apple juice” as classifications. At this time, the aggregating unit 20 specifies prediction targets with prediction target IDs=1, 6, 11, and 16 matching the commodity=“apple juice” and the timing=“March 2016” from the table exemplified in FIG. 2. Then, the aggregating unit 20 specifies prediction models for the prediction targets from the table exemplified in FIG. 4.

Note that, when the accepting unit 10 accepts an upper classification in the hierarchical structure, the aggregating unit 20 may judge that all lower classifications belonging to that classification are designated and specify all prediction targets of the matching classifications.

For example, in the example illustrated in FIG. 2, when “fruit juice beverage” is designated as a commodity classification, the aggregating unit 20 may specify prediction targets identified by prediction target IDs=1 to 5.

Then, the aggregating unit 20 aggregates the weights of the explanatory variables for each explanatory variable included in the specified prediction models. Specifically, the aggregating unit 20 calculates the total sum of the weights for each explanatory variable included in the specified prediction models, thereby aggregating the weight of each explanatory variable. When the prediction formula is represented by a linear regression equation, since the weight of the explanatory variable corresponds to a coefficient, the aggregating unit 20 aggregates the coefficients of the explanatory variables for each explanatory variable.

Since the explanatory variable with a larger weight has a higher degree of contribution to the prediction result, in the following description, the weight specified for each explanatory variable or an aggregated value of the weights aggregated from a predetermined viewpoint is referred to as the degree of contribution of the explanatory variable. Note that the degree of contribution of the explanatory variable may be simply referred to as the degree of contribution hereinafter in some cases.

In addition, in the following description, the total sum of the weights for each explanatory variable included in the prediction models for the specified prediction targets is referred to as a first degree of contribution.

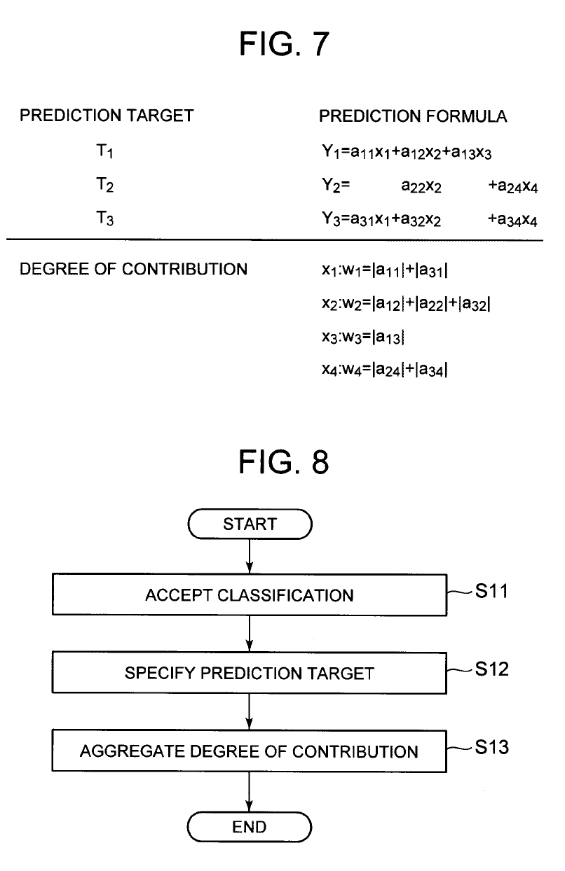

FIG. 7 is an explanatory diagram illustrating an example of a process of calculating the total sums of the weights of the explanatory variables (first degrees of contribution). The example illustrated in FIG. 7 indicates that three types of prediction targets T₁ to T₃ are specified and prediction formulas Y₁ to Y₃ are also specified, respectively. In addition, the example illustrated in FIG. 7 assumes that four types of explanatory variables x₁ to x₄ are included in the three specified prediction formulas in total. Note that it is unnecessary for each prediction formula to include all explanatory variables.

The aggregating unit 20 calculates the total sum of the weights of each explanatory variable. In the example illustrated in FIG. 7, the aggregating unit 20 calculates the total sum of coefficients for each of the explanatory variables x₁ to x₄. When the total sum of the weights is calculated, the absolute value of the coefficient is used as the weight in order to indicate a degree of contribution by each explanatory variable. For example, when the degree of contribution w₁ of the explanatory variable x₁ is calculated, the aggregating unit 20 calculates the degree of contribution by w₁=|a₁₁|+|a₃₁|. The same applies to the other explanatory variables. The aggregating unit 20 outputs the aggregation result to the output unit 40.

Note that the value of the coefficient may be used as the weight instead of the absolute value of the coefficient. Specifically, the weight may be a signed value. In this case, the aggregating unit 20 may calculate the total sum of the weights of each explanatory variable while canceling out a positive coefficient and a negative coefficient (that is, by performing addition and subtraction in line with the signs). In addition, the aggregating unit 20 may separately aggregate a positive degree of contribution and a negative degree of contribution for one explanatory variable. In this manner, since the aggregating unit 20 aggregates the degree of contribution of one explanatory variable for each sign, it is possible to use one explanatory variable from the viewpoints of two explanatory variables.

Note that the aggregating unit 20 may standardize the coefficients included in each prediction formula. Specifically, the aggregating unit 20 may correct each coefficient such that the total value of the coefficients in each prediction formula becomes one (that is, the average becomes zero and the dispersion becomes one). For example, in the case of the prediction formula Y₁ exemplified in FIG. 7, the aggregating unit 20 standardizes coefficients a₁₁, a₁₂, and a₁₃ included in Y₁. Note that the standardization may be performed on the calculated total sum of the weights after the total sum of the weights of each explanatory variable is calculated.

In addition, the aggregating unit 20 may calculate the ratio of the calculated degree of contribution (first degree of contribution) of each explanatory variable. Specifically, the aggregating unit 20 may calculate, for each explanatory variable, the ratio of the first degree of contribution of each explanatory variable to the total sum of the first degrees of contribution. For example, it is assumed that the prediction formula exemplified in FIG. 7 is employed and the first degrees of contribution of the explanatory variables x₁ to x₄ are assigned as w₁ to w₄, respectively. At this time, for example, the aggregating unit 20 may calculate the ratio of the first degree of contribution w₁ of the explanatory variable x₁ by w₁/w₁+w₂+w₃+w₄. The same applies to the method of calculating the ratios of the first degrees of contribution of the other explanatory variables.

Furthermore, the aggregating unit 20 may standardize the degrees of contribution calculated for each explanatory variable. Specifically, the aggregating unit 20 may correct each degree of contribution such that the total value of the degrees of contribution of the respective explanatory variables becomes one (that is, the average becomes zero and the dispersion becomes one). For example, in the case of the example illustrated in FIG. 7, the aggregating unit 20 standardizes the respective calculated the first degrees of contribution w₁, w₂, w₃, and w₄ of each explanatory variable. By performing such standardization, it becomes possible to compare the standardized degree of contribution with another degree of contribution of different scale.

In this manner, the aggregating unit 20 standardizes the coefficients in each prediction formula or calculates the ratio of the degree of contribution, such that comparison with the degree of contribution of another explanatory variable becomes easy.

The accepting unit 10, the aggregating unit 20, and the output unit 40 are implemented by a central processing unit (CPU) of a computer working in accordance with a program (information processing program). For example, the program may be stored in the storage unit 30 such that the CPU reads this program and works as the accepting unit 10 and the aggregating unit 20 in accordance with the program. Alternatively, the functions of the information processing system may be provided in a software as a service (SaaS) format.

In addition, the accepting unit 10, the aggregating unit 20, and the output unit 40 may each be implemented by dedicated hardware. Furthermore, some or all of constituent elements of each device may be implemented by a general-purpose or dedicated circuitry, processor, or the like, or a combination thereof. These mechanisms may be constituted by a single chip or may be constituted by a plurality of chips connected via a bus. Some or all of constituent elements of each device may be implemented by a combination of the above-mentioned circuitry or the like and the program.

In a case where some or all of constituent elements of each device is implemented by a plurality of information processing devices, circuitry, or the like, the plurality of information processing devices, the circuitry, or the like may be concentratedly arranged or may be arranged in a distributed manner. For example, information processing devices, circuitry, or the like may be implemented as a mode in which respective members are connected via a communication network, such as a client and server system and a cloud computing system.

Next, the action of the information processing system of the present exemplary embodiment will be described. FIG. 8 is a flowchart illustrating an action example of the information processing system 100 of the first exemplary embodiment. First, the accepting unit 10 accepts a classification that specifies a prediction target (step S11). Next, the aggregating unit 20 specifies a prediction target from the accepted classification (step S12) and aggregates the degree of contribution determined by the prediction model corresponding to the specified prediction target for each explanatory variable (step S13). Specifically, the aggregating unit 20 calculates, for each explanatory variable, the total sum of the weights of the explanatory variable included in the prediction models for the specified prediction targets as the first degree of contribution.

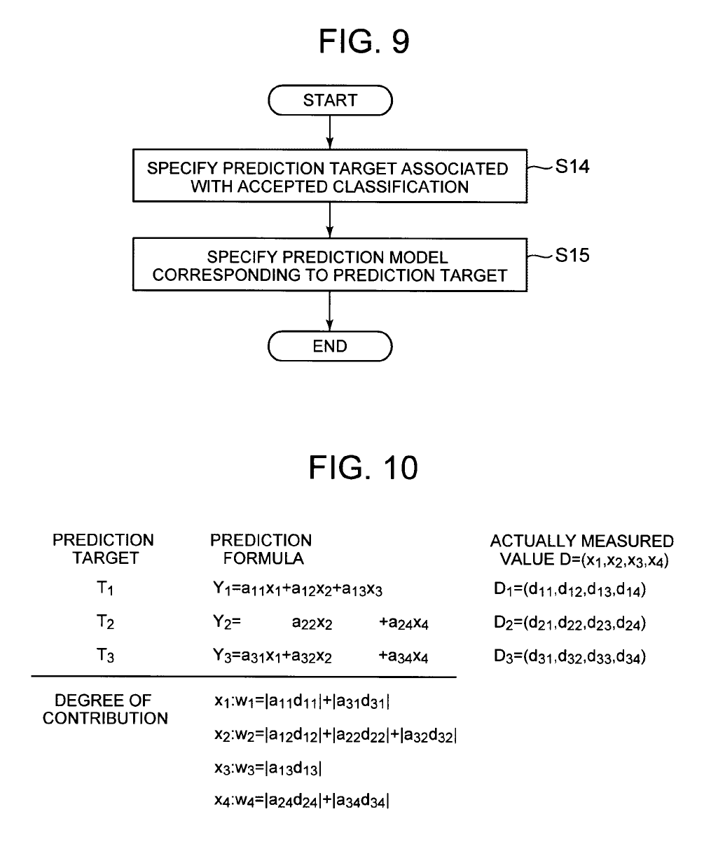

Next, an action of specifying a prediction model from the accepted classification will be described. FIG. 9 is a flowchart illustrating an example of an action of specifying a prediction model to be aggregated based on information accepted by the accepting unit 10 from among the prediction models stored in the storage unit 30. Here, the storage unit 30 is assumed to store a table in which the prediction target and the classification are associated with each other as exemplified in FIG. 2 and a table in which the prediction target and the prediction model are associated with each other as exemplified in FIG. 4.

The aggregating unit 20 specifies a prediction target associated with the accepted classification from the table exemplified in FIG. 2 (step S14). Specifically, the aggregating unit 20 specifies a prediction target ID that identifies a prediction target from the table exemplified in FIG. 2. Then, the aggregating unit 20 specifies a prediction model corresponding to the prediction target from the table exemplified in FIG. 4 (step S15). Specifically, the aggregating unit 20 specifies the explanatory variable and the weight of the explanatory variable from the table exemplified in FIG. 4 with the specified prediction target ID and specifies the prediction model including that explanatory variable.

As described above, in the present exemplary embodiment, the accepting unit 10 accepts a classification that specifies a prediction target and the aggregating unit 20 deals with the prediction target specified by the accepted classification to aggregate, for each variable, the degree of contribution determined by the prediction model corresponding to that prediction target. Therefore, a factor that can contribute to the prediction result can be analyzed.

That is, in the present exemplary embodiment, the accepting unit 10 accepts the classifications of the prediction targets, such that the aggregating unit 20 can narrow down the analysis targets. In addition, since the aggregating unit 20 performs aggregation by focusing on the weights (coefficients) of each explanatory variable, which are factors that can contribute to the prediction target, the user can grasp a degree of influence (a degree of contribution) of each factor.

Hereinafter, effects of the present exemplary embodiment will be described in detail with specific examples.

In the invention of the present application, a situation in which a large amount of prediction models is created is supposed. That is, in the present exemplary embodiment, a prediction model is created for each prediction target finely sorted and a factor is analyzed by aggregating a plurality of created prediction models.

For example, a situation is supposed in which there are the classification of “fruit juice beverage” and only three types of “orange juice”, “grape juice”, and “apple juice” as lower classifications of “fruit juice beverage”. When a factor is analyzed by focusing on “fruit juice beverage”, conceivable methods are (1) a method of analyzing a factor based on a prediction model created for whole fruit juice beverages and (2) a method of analyzing a factor by aggregating the prediction models created for each of orange juice, grape juice, and apple juice.

As in the invention of the present application, in a case where a prediction model is created for each prediction target finely sorted, the accuracy of factor analysis is enhanced when a factor is analyzed by aggregating prediction models created for individual prediction targets as in the above (2). For example, it is assumed that a campaign A is made for orange juice and another campaign B is made for apple juice. In this case, the reason is that finer factors (explanatory variables) can be taken into consideration by factor analysis on individual prediction models created with fine granularity rather than factor analysis for the entire “fruit juice beverage”. In particular, when an upper limit of the types of explanatory variables included in the prediction model is restricted in order to raise the easiness of interpretation of the model and to prevent over learning, more remarkable effects are exerted.

In addition, by creating prediction models in fine units, the effect of being able to aggregate freely from various viewpoints (stores, commodities, timing, and the like) also can be obtained.

Note that the aggregating unit 20 may standardize common coefficients of the explanatory variable. Specifically, the aggregating unit 20 may correct each coefficient such that the total value of the coefficients of each explanatory variable becomes one (the average becomes zero and the dispersion becomes one). For example, in the case of the explanatory variable x₁ exemplified in FIG. 7, the aggregating unit 20 standardizes coefficients a₁₁ and a₃₁ included in Y₁ and Y₃.

In addition, the aggregating unit 20 may calculate the ratio of the coefficient of the explanatory variable between the respective prediction formulas. Specifically, the aggregating unit 20 may calculate the ratio of the coefficient of the explanatory variable to the calculated total sum of the coefficients of the explanatory variable for each prediction target. For example, the ratio of the coefficient of the explanatory variable x₁ exemplified in FIG. 7 may be calculated by a₁₁/a₁₁+a₃₁. The same applies to the method of calculating the ratios of the coefficients of the other explanatory variables.

In this manner, the aggregating unit 20 standardizes the coefficients of each explanatory variable or calculates the ratio of the coefficient, such that the degree of contribution to the same explanatory variable can be compared for each prediction target.

### Second Exemplary Embodiment

Next, a second exemplary embodiment of the information processing system according to the present invention will be described. The configuration of the second exemplary embodiment is the same as the configuration of the first exemplary embodiment. However, the present exemplary embodiment is different from the first exemplary embodiment in that an aggregating unit 20 calculates the degree of contribution including the actually measured value of the explanatory variable. Note that the action of an accepting unit 10 is the same as that of the first exemplary embodiment.

In the present exemplary embodiment, it is assumed that the prediction model is represented by a linear regression equation including a plurality of explanatory variables. The aggregating unit 20 specifies a prediction target based on the accepted classification and specifies a prediction model for the specified prediction target. In addition, the aggregating unit 20 also specifies an actually measured value of an explanatory variable included in that prediction model based on the accepted classification. The actually measured value is stored, for example, in a storage unit 30.

The aggregating unit 20 calculates the product of the weight (coefficient) of the explanatory variable in the linear regression equation and the actually measured value of this explanatory variable for each explanatory variable. Then, the aggregating unit 20 calculates the total sum of the calculated products for each explanatory variable to employ as the degree of contribution. In the following description, the total sum of the products calculated for each explanatory variable is referred to as a second degree of contribution.

FIG. 10 is an explanatory diagram illustrating an example of a process of calculating the total sum of the products calculated for each explanatory variable (second degree of contribution). In the example illustrated in FIG. 10, similarly to the example illustrated in FIG. 7, it is assumed that three types of prediction targets T₁ to T₃ are specified, prediction formulas Y₁ to Y₃ are also specified, respectively, and four types of explanatory variables x₁ to x₄ are included in the three specified prediction formulas in total. In addition, the example illustrated in FIG. 10 assumes that actually measured values D₁ to D₃ of the explanatory variables x₁ to x₄ are also specified for the prediction target T₁ to T₃, respectively.

The aggregating unit 20 calculates the product of the coefficient and the actually measured value of the explanatory variable for each explanatory variable. In the example illustrated in FIG. 10, the aggregating unit 20 calculates the degree of contribution, for example, by w₁=|a₁₁d₁₁|+|a₃₁d₃₁| for the explanatory variable x₁. The same applies to the other explanatory variables.

Note that, as in the first exemplary embodiment, the aggregating unit 20 may standardize the products of the coefficients and the actually measured values of the explanatory variables calculated by each prediction formula. Specifically, the aggregating unit 20 may correct each product such that the total value of the products becomes one (the average becomes zero and the dispersion becomes one). Note that the standardization may be performed after the total sum of the products of the respective explanatory variables is calculated.

In addition, the aggregating unit 20 may calculate the ratio of the calculated degree of contribution (second degree of contribution) of each explanatory variable. Specifically, the aggregating unit 20 may calculate, for each explanatory variable, the ratio of the second degree of contribution of each explanatory variable to the total sum of the second degrees of contribution.

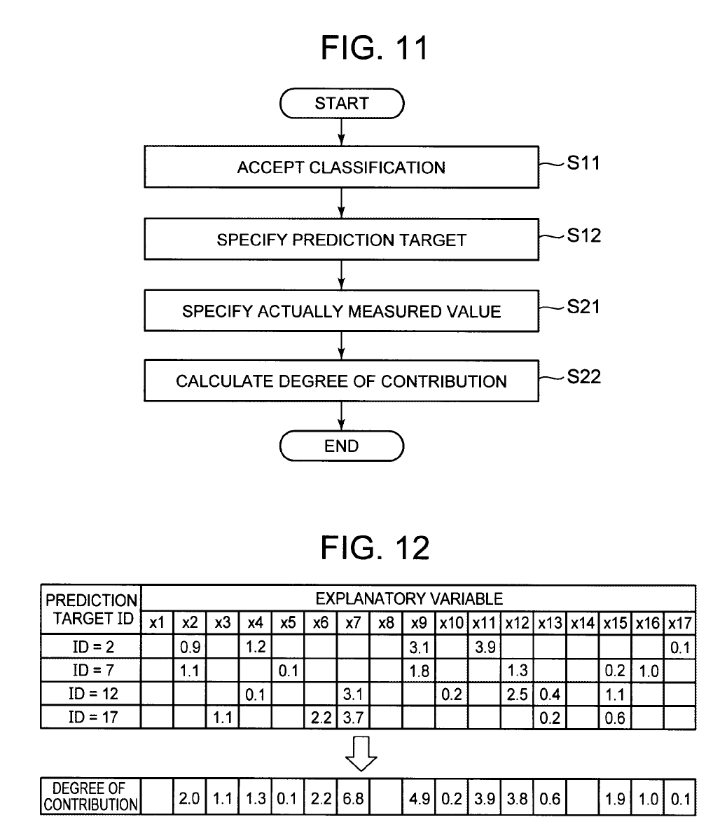

Next, the action of an information processing system of the present exemplary embodiment will be described. FIG. 11 is a flowchart illustrating an action example of the information processing system 100 of the second exemplary embodiment. First, the accepting unit 10 accepts a classification that specifies a prediction target (step S11). Next, the aggregating unit 20 specifies a prediction target from the accepted classification (step S12) and additionally specifies an actually measured value (step S21). Then, the aggregating unit 20 calculates the product of the weight (coefficient) of the explanatory variable and the actually measured value of this explanatory variable for each explanatory variable and calculates the total sum of the calculated products for each explanatory variable as the second degree of contribution (step S22).

As described above, in the present exemplary embodiment, the aggregating unit 20 calculates the product of the coefficient that is the weight of the explanatory variable in the linear regression equation and the actually measured value of this explanatory variable for each explanatory variable and calculates the total sum of the calculated products for each explanatory variable as the second degree of contribution. Therefore, in addition to the effects of the first exemplary embodiment, analysis that reflects the performance value is enabled.

Hereinafter, effects of the present exemplary embodiment will be described in detail with specific examples.

For example, it is assumed that “the number of sales of orange juice on a certain day in March 2016 at a shop A” is explained by the following prediction formula. Here, the explanatory variables are represented in the parentheses.

Number of sales=−11.3*(highest temperature in the month in the vicinity of the shop A)+60*(total precipitation of the day in the vicinity of the shop A)+130

Judging from the above formula alone, it seems at a glance that total precipitation of the day contributes greatly to the number of sales of orange juice on the certain day in March at the shop A, as the value of the coefficient thereof is large. However, it is assumed that, in reality, it was not rain at all in the vicinity of the shop A on the certain day in March. In that case, it can be said that, in reality, the total precipitation of the day in the vicinity of the shop A did not contribute at all to the number of sales of orange juice on the certain day in March at the shop A.

Accordingly, in the present exemplary embodiment, as compared with the first exemplary embodiment, the degree of contribution of a specific explanatory variable is calculated by the value of the product of “the value of the coefficient in the prediction formula” and “the actually measured value of the explanatory variable concerning this coefficient”, such that analysis that reflects the performance value is enabled.

Note that, as in the first exemplary embodiment, the aggregating unit 20 may standardize the products of the coefficients and the actually measured values of the explanatory variable with respect to a common explanatory variable. Specifically, the aggregating unit 20 may correct the value of each product such that the total value of the products for each explanatory variable becomes one (the average becomes zero and the dispersion becomes one).

In addition, the aggregating unit 20 may calculate, for each explanatory variable, the ratio of the product of the coefficient and the actually measured value of the explanatory variable between the respective prediction formulas. Specifically, the aggregating unit 20 may calculate, for each prediction formula, the ratio of the product of each explanatory variable to the total sum of the products calculated for the explanatory variables.

Next, modifications of the second exemplary embodiment will be described. In the second exemplary embodiment, the method of calculating the degree of contribution using the actually measured value has been described. Meanwhile, the result also can be predicted using the prediction model. In this case, it is possible to specify a difference (error) between a prediction result predicted based on the prediction model and an actual measurement result actually acquired. Therefore, the aggregating unit 20 may correct the degree of contribution using the error as a difference between the prediction result predicted based on the prediction model and the actual measurement result actually acquired.

For example, the aggregating unit 20 may correct, for each prediction target, the degree of contribution of each explanatory variable by the same percentage based on a difference between the prediction result and the actual measurement result. For example, when the actual measurement result takes a value of twice the value of the prediction result, the aggregating unit 20 may double each of the degrees of contribution of the respective explanatory variables.

Besides, for example, the aggregating unit 20 may provide a new explanatory variable indicating a difference between the prediction result and the actual measurement result and employ the difference as the degree of contribution of the new explanatory variable.

Note that a method by which the aggregating unit 20 corrects the degree of contribution according to the error is not limited to the above example. The aggregating unit 20 may change the percentage by which the degree of contribution is corrected, or two or more new explanatory variables may be provided.

### Third Exemplary Embodiment

Next, a third exemplary embodiment of the information processing system according to the present invention will be described. In the first and second exemplary embodiments, the method of calculating the degree of contribution for each explanatory variable has been described. Meanwhile, it is also supposed that the number of explanatory variables used for prediction will grow extremely large. That is, if the factors used for analysis are sorted too finely, the number of types of explanatory variables becomes very enormous when consolidated and there is a possibility that the interpretability may be affected.

The reason why the number of types of explanatory variables becomes enormous will be explained below with specific examples. For example, in a case where a company developing 1000 retail stores nationwide predicts the sales volume of 2000 types of commodities per store per month, the number of prediction models therefor in one year sums up to 1000 (stores)×12 (months/year)×2000 (types/month and store)=24,000,000.

Here, it is assumed that an operator wishes to analyze a factor of sales with respect to the sales of a specific commodity in a specific month nationwide. In this case, an accepting unit 10 accepts, from the operator, the classification of “the number of sales of orange juice on a certain day in March 2016” as a classification that specifies a prediction target. According to the classification accepted by the accepting unit 10, prediction models for 1000 stores are specified. That is, a prediction model that predicts the number of sales of orange juice on a certain day in March 2016 at each of 1000 stores is specified.

Meanwhile, as the number of prediction models increases, the types of explanatory variables included in these prediction models also increase. This will be explained by taking the prediction models illustrated in FIG. 4 as an example. FIG. 12 is an explanatory diagram illustrating an example of a process of analyzing a factor using a plurality of prediction models. Here, it is assumed that a factor of the sales of orange juice on a certain day in March 2016 at a shop A to a shop D is analyzed. Even for the same commodity (for example, orange juice) at the same timing (for example, March 2016), a factor (that is, an explanatory variable) contributing to sales is considered to vary depending on stores.

For example, in the example illustrated in FIG. 4, factors (that is, explanatory variables) contributing to the sales of orange juice at the shop A are considered to be factors indicated by the explanatory variables x₂, x₄, x₉, x₁₁, and x₁₇ included in a prediction model specified by a prediction target ID=2. On the other hand, factors (that is, explanatory variables) contributing to the sales of orange juice at the shop B are considered to be factors indicated by explanatory variables x₂, x₅, x₉, x₁₂, x₁₅, and x₁₆ included in a prediction model specified by a prediction target ID=7. Similarly, factors indicated by explanatory variables x₄, x₇, x₁₀, x₁₂, x₁₃, and x₁₅ included in a prediction model specified by a prediction target ID=12 are considered for the shop C, whereas factors indicated by explanatory variables x₃, x₆, x₇, x₁₃, and x₁₅ included in a prediction model specified by a prediction target ID=17 are considered for the shop D.

When all these factors are aggregated, it can be seen that the sales of orange juice in March 2016 at the shop A to the shop D are affected by the factors indicated by the explanatory variables x₂, x₃, x₄, x₅, x₆, x₇, x₉, x₁₀, x₁₁, x₁₂, x₁₃, x₁₅, x₁₆, and x₁₇. However, too many explanatory variables to be considered may affect the interpretability. As a result, if the aggregating unit 20 performs an aggregating process on a large amount of prediction models, there are fears that a human being has a difficulty in interpreting a result of such aggregation because the types of explanatory variables included in the prediction models grow too large. That is, even if the number of explanatory variables constituting one prediction formula is not so large, as the number of prediction formulas becomes larger, the types of explanatory variables included therein may increase. Accordingly, the present exemplary embodiment will describe a method that can analyze a factor that can contribute to a prediction target from a more global viewpoint.

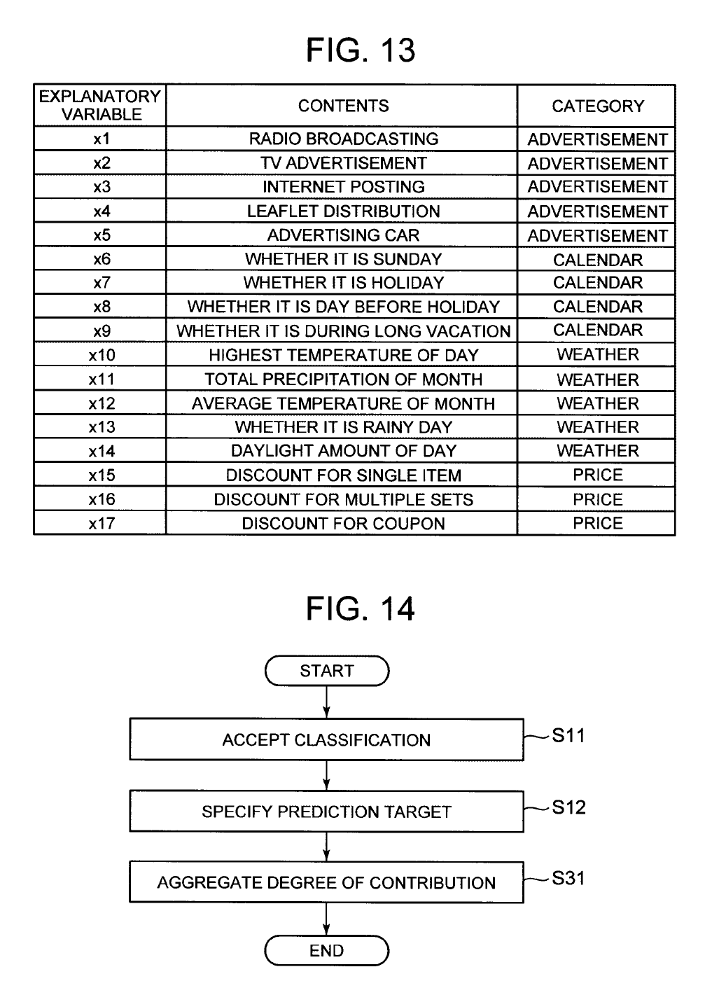

In the present exemplary embodiment, a category indicating the properties of a variable is set in each explanatory variable. However, the category may be set in the explanatory variables of the first and second exemplary embodiments. FIG. 13 is an explanatory diagram illustrating an example of explanatory variables in which categories are set.

For example, when explanatory variables such as “TV advertisement”, “Internet posting”, and “leaflet distribution” are included in a prediction model, the category of “advertisement” is set in these explanatory variables, for example. In addition, for example, assuming that a prediction target is predicted every day, when explanatory variables such as “whether it is Sunday”, “whether it is a holiday”, and “whether it is the day before the holiday” are included in a prediction model, the category of “calendar” is set in these explanatory variables, for example. Furthermore, for example, assuming that a prediction target is predicted every day, when explanatory variables such as “whether it is rainy day”, “highest temperature”, and “daylight amount” are included in a prediction model, the category of “weather” is set in these explanatory variables, for example. A relationship between the explanatory variable and a category to which this explanatory variable belongs is assumed to be, for example, preset.

The configuration of the third exemplary embodiment is also the same as the configurations of the first and second exemplary embodiments. However, the present exemplary embodiment is different from the other exemplary embodiments in that an aggregating unit 20 calculates the degree of contribution by summarizing the explanatory variables into each category set in the explanatory variables. Note that whether the degree of contribution is calculated for each category or the degree of contribution is calculated for each explanatory variable may be determined in advance or a method for calculating the degree of contribution may be accepted by the accepting unit 10.

First, the aggregating unit 20 calculates the degree of contribution for each explanatory variable. The aggregating unit 20 may calculate the first degree of contribution described in the first exemplary embodiment as the degree of contribution for each explanatory variable or may calculate the second degree of contribution described in the second exemplary embodiment as the degree of contribution for each explanatory variable.

Next, the aggregating unit 20 aggregates the calculated degrees of contribution for each category of the explanatory variable. For example, when the explanatory variable x₁ and the explanatory variable x₂ exemplified in FIG. 7 belong to the same category, the aggregating unit 20 adds the degree of contribution w₁ of the explanatory variable x₁ and the degree of contribution w₂ of the explanatory variable x₂ to employ as the degree of contribution of this category. In the following description, the degree of contribution aggregated for each category is referred to as a third degree of contribution.

Also in the present exemplary embodiment, the aggregating unit 20 may standardize the degrees of contribution aggregated for each category. Specifically, the aggregating unit 20 may correct each degree of contribution such that the total value of the degrees of contribution aggregated for each category becomes one (that is, the average becomes zero and the dispersion becomes one).

In addition, the aggregating unit 20 may calculate the ratio of the degree of contribution (third degree of contribution) aggregated for each category. Specifically, the aggregating unit 20 may calculate, for each category, the ratio of the third degree of contribution of each category to the total sum of the third degrees of contribution.

Next, the action of an information processing system of the present exemplary embodiment will be described. FIG. 14 is a flowchart illustrating an action example of the information processing system 100 of the third exemplary embodiment. First, the accepting unit 10 accepts a classification that specifies a prediction target (step S11). Next, the aggregating unit 20 specifies a prediction target from the accepted classification (step S12) and, for each group of the explanatory variables of the common category included in a prediction model for the specified prediction target, aggregates the weights of this category as the degree of contribution (third degree of contribution) (step S31).

As described above, in the present exemplary embodiment, the aggregating unit 20 aggregates the degrees of contribution calculated for respective explanatory variables for each category of these explanatory variables to calculate as the third degrees of contribution. Therefore, in addition to the effects of the first or second exemplary embodiment, analysis from a more global viewpoint is enabled.

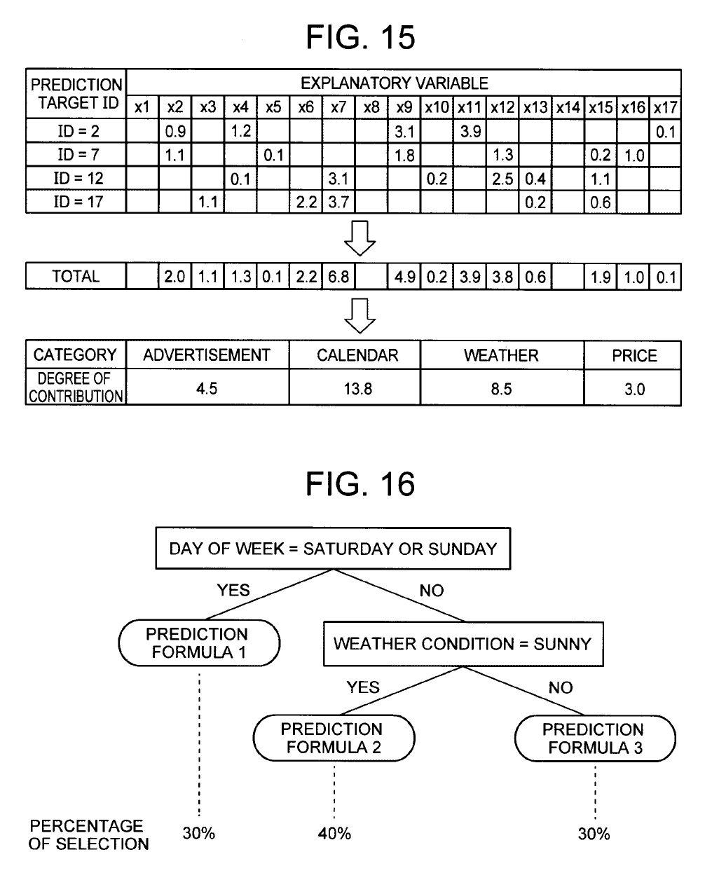

FIG. 15 is an explanatory diagram illustrating an example in a case where the degrees of contribution are aggregated for each category. In the example illustrated in FIG. 12, there are 14 types of factors (that is, explanatory variables), but the factors are consolidated into four types of advertisement, calendar, weather, and price through aggregation by category. In addition, by aggregating a large amount of resembling explanatory variables, it becomes possible to enhance the interpretability of the factors. For example, in the example illustrated in FIG. 15, it is easy to judge at a glance that the factors relating to the category “calendar” are dominant.

Note that, as in the first or second exemplary embodiment, the aggregating unit 20 may standardize the degrees of contribution aggregated for each category by respective prediction formulas. Specifically, the aggregating unit 20 may correct each degree of contribution such that the total value of the degrees of contribution for the respective categories becomes one (the average becomes zero and the dispersion becomes one).

In addition, the aggregating unit 20 may calculate the ratio of the degree of contribution for each category between the respective prediction formulas. Specifically, the aggregating unit 20 may calculate, for each prediction formula, the ratio of the degree of contribution of each category to the total sum of the degrees of contribution calculated for the respective categories.

### Fourth Exemplary Embodiment

Next, a fourth exemplary embodiment of the information processing system according to the present invention will be described. The configuration of the fourth exemplary embodiment is also the same as the configuration of the first exemplary embodiment. However, the present exemplary embodiment will describe a method of calculating the degree of contribution using a prediction model in which a prediction formula is specified according to the value (actually measured value) of a variable to be applied. As the prediction model in which a prediction formula is specified according to the actually measured value, for example, there is a conditional predictor that specifies one prediction formula according to a sample. Note that the action of an accepting unit 10 is the same as that of the first exemplary embodiment.

FIG. 16 is an explanatory diagram illustrating an example of the conditional predictor. FIG. 16 schematically illustrates that the prediction formula varies depending on the sample. The predictor exemplified in FIG. 16 indicates that a prediction formula 1 is used when the day of the week indicated by the sample is Saturday or Sunday (weekend), a prediction formula 2 is used when it is sunny on a day excluding the weekend, and a prediction formula 3 is used in a case other than the above cases. In addition, the percentage of selection exemplified in FIG. 16 indicates a percentage at which each prediction formula is selected according to a sample. In other words, since the prediction formula is selected according to the sample, it can be said that the percentage of selection indicates the percentage of the number of samples corresponding to the prediction formula. Additionally, it can be said that the conditional predictor described in the present exemplary embodiment represents a prediction model in which a prediction formula is specified according to the actually measured value.

The aggregating unit 20 uses a prediction model in which a prediction formula is specified according to the value of a variable to be applied (that is, the conditional predictor) to calculate the degree of contribution for each explanatory variable. Specifically, the aggregating unit 20 specifies a matching prediction formula for each sample to be used, using the above conditional predictor.

Thereafter, the aggregating unit 20 may calculate the first degree of contribution indicated in the first exemplary embodiment (that is, the total sum of the weights of the explanatory variable included in the prediction models for the specified prediction targets), or the second degree of contribution indicated in the second exemplary embodiment (that is, the total sum of the products calculated for each explanatory variable). In addition, the aggregating unit 20 may calculate the third degree of contribution indicated in the third exemplary embodiment (that is, the degree of contribution aggregated for each category).

For example, when the first degree of contribution is calculated, the aggregating unit 20 calculates, for each prediction formula, the percentage of a sample used for specifying the prediction formula. In the example illustrated in FIG. 16, the percentage of a sample used for specifying the prediction formula 1 is 30%, the percentage of a sample used for specifying the prediction formula 2 is 40%, and the percentage of a sample used for specifying the prediction formula 3 is 30%.

Next, the aggregating unit 20 corrects the coefficient according to the calculated percentage. Specifically, the aggregating unit 20 multiplies the coefficient of the corresponding prediction formula by the calculated percentage. Then, the aggregating unit 20 aggregates the coefficients of the explanatory variable for each explanatory variable included in the specified prediction formula. This serves as the degree of contribution of each explanatory variable for one prediction target.

When the second degree of contribution is calculated, the aggregating unit 20 calculates, for each explanatory variable, the product of the coefficient of the explanatory variable in the prediction formula specified according to the sample and the value of this sample of the explanatory variable. Then, the aggregating unit 20 calculates the total sum of the calculated products for each explanatory variable to employ as the degree of contribution. This serves as the degree of contribution of each explanatory variable for one prediction target.

When the third degree of contribution is calculated, the aggregating unit 20 simply calculates the first degree of contribution or the second degree of contribution and then aggregates the degrees of contribution for each group of the explanatory variables of the common category.

As described above, in the present exemplary embodiment, the aggregating unit 20 calculates the degree of contribution for each explanatory variable using a prediction model in which a prediction formula is specified according to the value of a variable to be applied.

Therefore, in addition to the effects of the first to third exemplary embodiments, the degree of contribution can be calculated even using such a prediction model that a prediction formula is selected according to a sample.

Next, a specific example of the information processing system according to the invention of the present application will be described.

First, a method in which a user performs an aggregating process from various viewpoints on about 10 to 100 prediction models specified based on the classification accepted by the accepting unit 10 will be described in a first specific example. In the first specific example, it is assumed that the prediction models specified from the information exemplified in FIGS. 2 and 4 are stored in the storage unit 30.

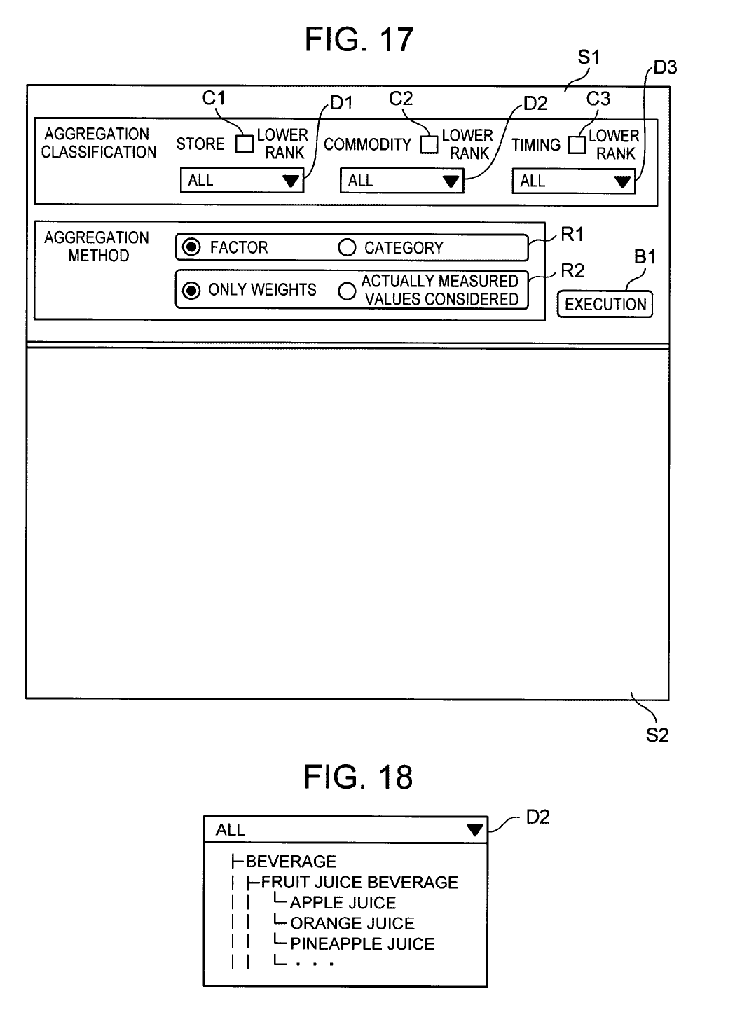

FIG. 17 is an explanatory diagram illustrating an example of an aggregation screen displayed by the output unit 40. The example illustrated in FIG. 17 assumes that an initial state of the aggregation screen is presented, where a screen S1 for designating a target to be analyzed is at the top and a screen S2 for displaying an aggregation result is at the bottom.

In addition, in the example illustrated in FIG. 17, the screen S1 is provided with drop-down lists D1 to D3 for each classification that specifies a prediction target. FIG. 18 is an explanatory diagram illustrating an example of information included in a drop-down list. The example illustrated in FIG. 18 indicates that fruit juice beverages are included in the beverage as the commodity classification and furthermore, a plurality of types of juices is included in the classification of the fruit juice beverage. Considering that the classification has a hierarchical structure, the output unit 40 may display the aggregation result according to a classification hierarchy.

In addition, in the example illustrated in FIG. 17, check boxes C1 to C3 are provided for each classification, which designate whether to display the aggregation result for each lower classification when an upper classification is selected.

On the screen S 1, a radio button R1 is also provided in order to designate an aggregation method, which is used to select whether to aggregate for each factor (that is, each explanatory variable) or to aggregate for each category. Furthermore, a radio button R2 is also provided on the screen S1, which is used to select whether to display the weight of the explanatory variable described in the first exemplary embodiment as the degree of contribution or to display the product of the explanatory variable and the performance value described in the second exemplary embodiment by considering also the actually measured value as the degree of contribution.

When a user selects a classification and an aggregation method and presses an execution button B1 exemplified in FIG. 17, the accepting unit 10 and the aggregating unit 20 perform the aggregating process and the output unit 40 outputs an aggregation result to the screen S2.

Hereinafter, an example of aggregation results in the case of accepting factor analysis from two types of viewpoints from the user will be described. The first type is a factor analysis of the sales of orange juice at all stores in Tokyo (that is, a shop A, a shop B, a shop C, and a shop D) in March 2016, whereas the second type is a factor analysis of the sales of whole fruit juice beverages (apple juice, orange juice, pineapple juice, grape juice, and peach juice) at a specific store (shop A) in March 2016.

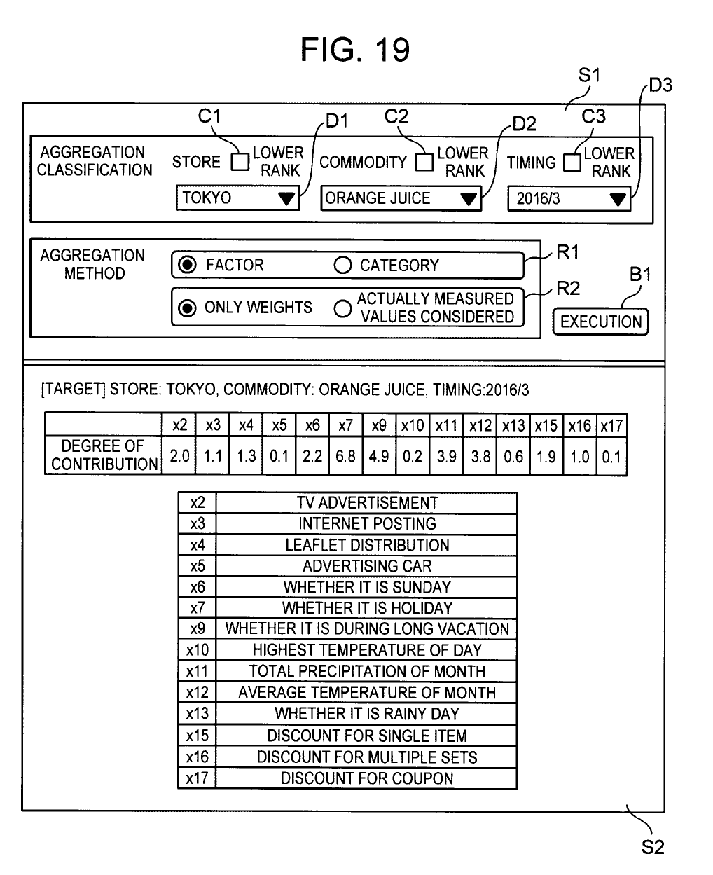

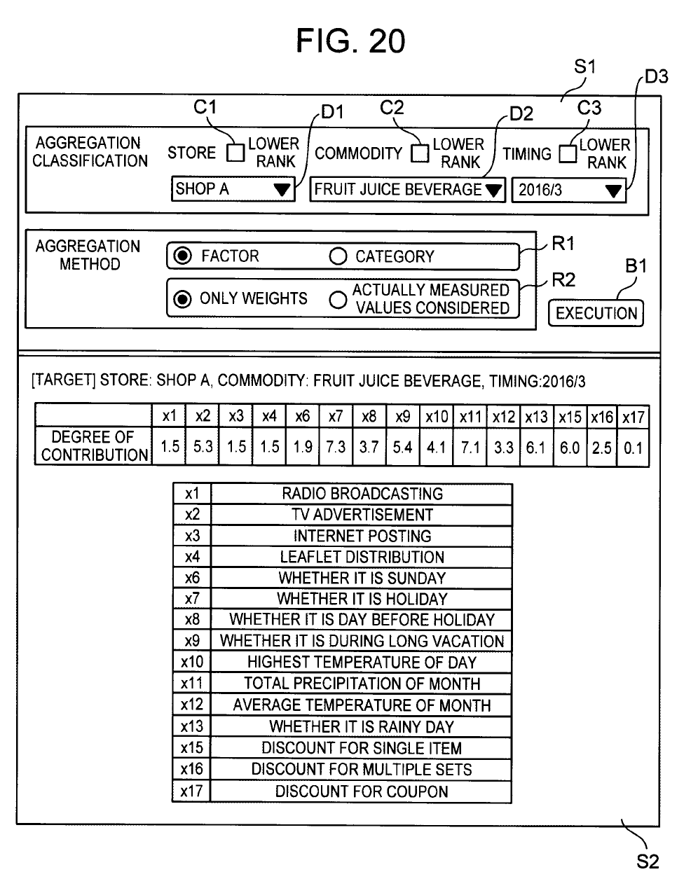

FIGS. 19 to 23 are explanatory diagrams illustrating examples of output result screens displayed by the output unit 40. FIG. 19 illustrates an example of the result of outputting factors of the sales of orange juice at all stores in Tokyo. In addition, FIG. 20 illustrates an example of the result of outputting factors of the sales of the whole fruit juice beverages at the shop A.

As exemplified in FIGS. 19 and 20, when the information processing system of the invention of the present application is used, a factor that can contribute to the prediction target can be analyzed from various viewpoints.

Note that, as illustrated in FIGS. 19 and 20, as the target prediction models increase, contributable factors (explanatory variables) also increase. Accordingly, as described in the third exemplary embodiment, it is possible to enhance the easiness of interpretability by aggregating factors (explanatory variables) for each category.

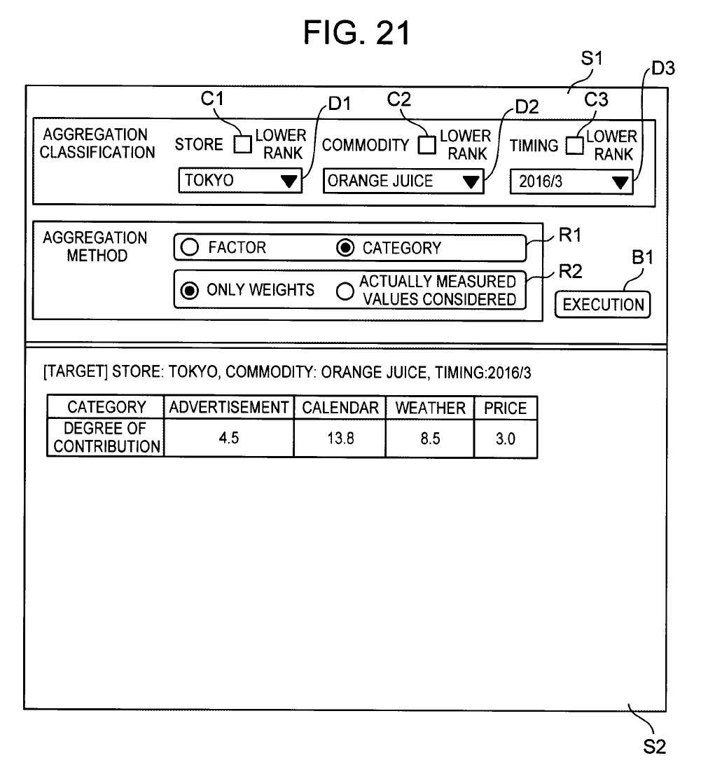

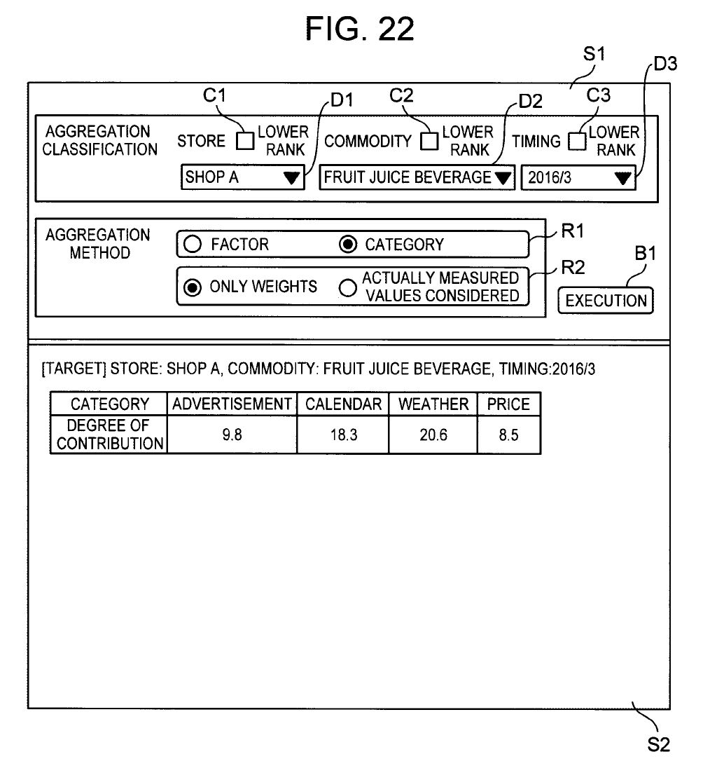

FIG. 21 illustrates an example of the result of aggregating factors of the sales of orange juice at all stores in Tokyo by categories to output. In addition, FIG. 22 illustrates an example of the result of aggregating factors of the sales of the whole fruit juice beverages at the shop A by categories to output. There are 14 factors in the example illustrated in FIG. 19, whereas factors are consolidated into four categories in the example illustrated in FIG. 21. Likewise, there are 15 factors in the example illustrated in FIG. 20, whereas factors are consolidated into four categories in the example illustrated in FIG. 22. In either case, it can be said that the interpretability is further enhanced.

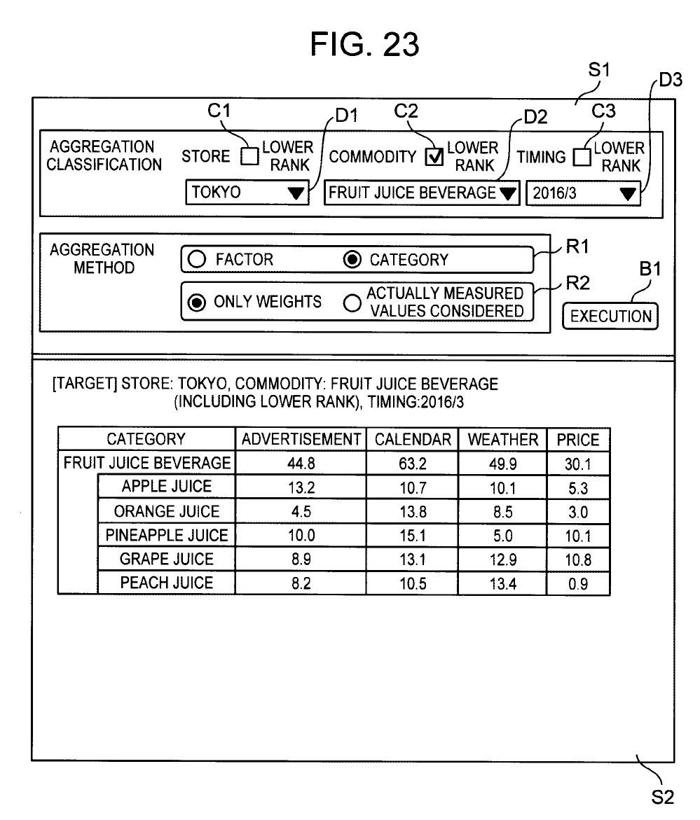

In addition, when an upper classification is designated, the output unit 40 may display the aggregation result for each classification included in the lower rank. FIG. 23 illustrates an example of outputting aggregation results of apple juice, orange juice, pineapple juice, grape juice, and peach juice included in the lower classification of the fruit juice beverage when factors of the sales of fruit juice beverages in Tokyo are analyzed for each category.

Next, a second specific example of the information processing system according to the invention of the present application will be described. In the second specific example, a method of visualizing factors of various prediction targets as a list will be described. In the second specific example, six categories of “location”, “weather”, “calendar”, “shelf allocation”, “price” and “advertisement” are supposed as categories to which the explanatory variables belong. In addition, “TV advertisement”, “Internet posting”, and “leaflet distribution” are supposed as three explanatory variables belonging to the “advertisement” category.

Furthermore, it is assumed that prediction targets for which sales are predicted are summarized into six groups of “whole beverages”, “fruit juice beverage”, “coffee”, “350 ml can, single item”, “350 ml can, set”, “500 ml plastic bottle, single item”, and “500 ml plastic bottle, set”. “Orange juice”, “grape juice”, and “apple juice” are assumed to be included in “fruit juice beverage” and the shop A is assumed to be situated in Tokyo included in the Kanto area. Additionally, sales in the Kanto area in January are supposed as an initial classification.

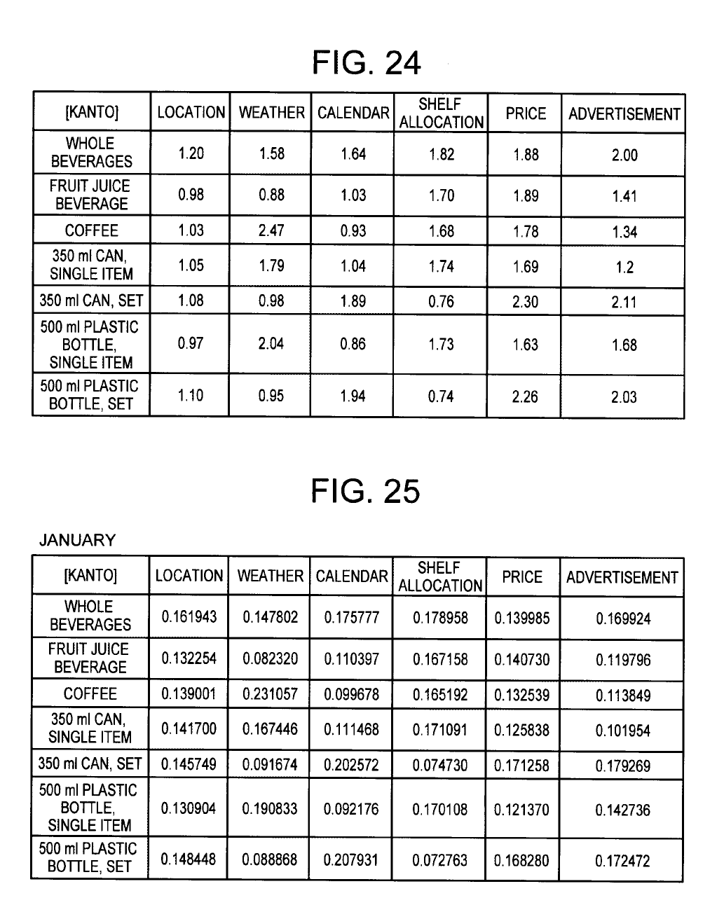

FIG. 24 is an explanatory diagram illustrating an example of the prediction models. The meaning of the table exemplified in FIG. 24 is the same as the meaning of the table exemplified in FIG. 4. That is, the vertical direction of the table indicates the prediction targets, whereas the horizontal direction of the table indicates weights of the explanatory variables representing the prediction models for those prediction targets. However, the prediction models indicated in this specific example have different contents of the prediction targets and the explanatory variables.

FIG. 25 is an explanatory diagram illustrating an example in which the weights of the prediction targets for each category are standardized based on the prediction models exemplified in FIG. 24. In order to generate the table exemplified in FIG. 25, with respect to the prediction models exemplified in FIG. 24, the aggregating unit 20 aggregates absolute values of the coefficients for each category of the explanatory variables and then standardizes these aggregated values. The coefficients exemplified in FIG. 25 correspond to the weights (degrees of contribution) of the present exemplary embodiment.

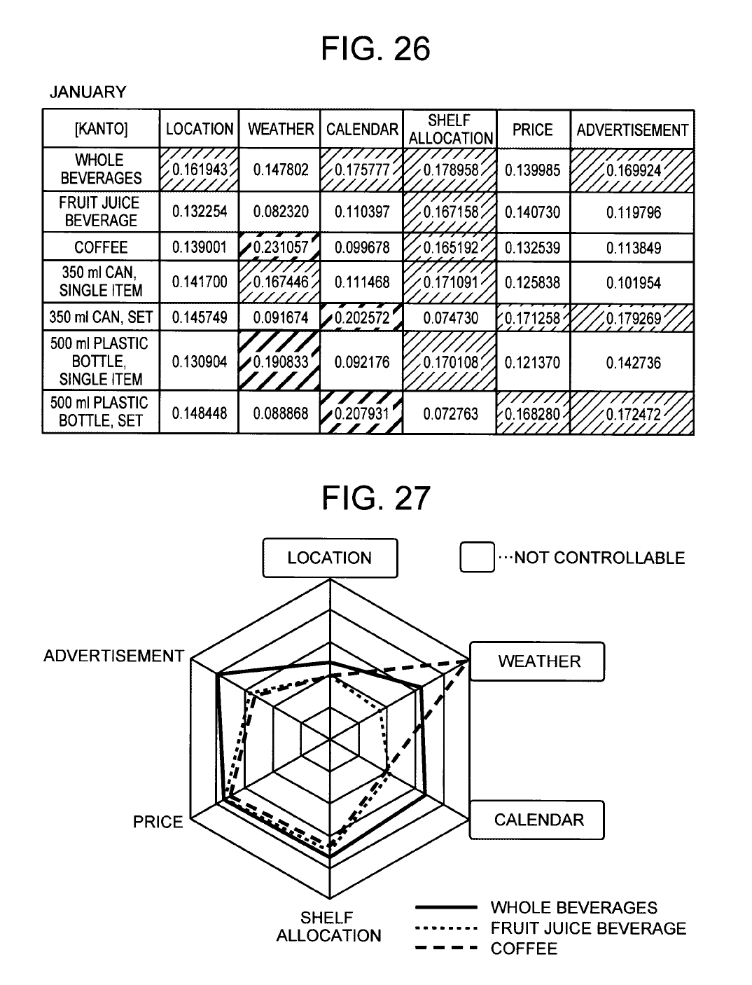

The output unit 40 may output the aggregation result exemplified in FIG. 25 in a heat map format. FIG. 26 is an explanatory diagram illustrating an example of outputting the aggregation results exemplified in FIG. 25 in the heat map format. By displaying the aggregation results in the heat map, the visibility of the overall trend can be improved.

In addition, the output unit 40 may output the aggregation result exemplified in FIG. 25 as a balance chart. FIG. 27 is an explanatory diagram illustrating an example of outputting the aggregation results exemplified in FIG. 25 as a balance chart. The balance chart exemplified in FIG. 27 is obtained by selecting three prediction results (“whole beverages”, “fruit juice beverage”, and “coffee”) out of the prediction results exemplified in FIG. 25 to output.

In addition, the output unit 40 may display a result of aggregation for a category including a directly controllable explanatory variable and a result of aggregation for a category including an explanatory variable not directly controllable in a form distinguishable from each other.

In the example illustrated in FIG. 27, the aggregation results of “advertisement”, “price”, and “shelf allocation” which are categories including directly controllable explanatory variables, and “location”, “weather”, and “calendar” which are categories including explanatory variables not directly controllable are distinguished from each other by displaying headlines surrounded with black frames. However, the method for distinguishing is not limited to the method of altering the form of the headline itself and, for example, the form of a value to be output or a plot may be altered.

Note that the results of aggregation for each category are output in the example illustrated in FIG. 27, but the same is true in the case of outputting the result of aggregation for each explanatory variable. In this case, the output unit 40 can display a result of aggregation for a directly controllable explanatory variable and a result of aggregation for an explanatory variable not directly controllable in a form distinguishable from each other.

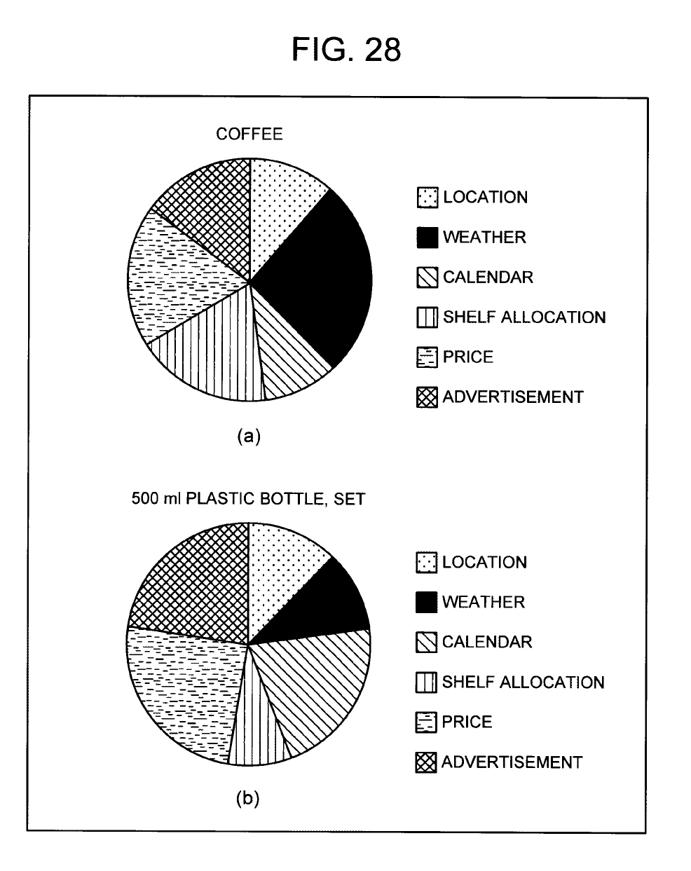

In addition, the output unit 40 may visualize the ratio of the degree of contribution of each explanatory variable to the calculated total sum of the degrees of contribution of the explanatory variables. FIG. 28 is an explanatory diagram illustrating an example of visualizing the ratio of the degree of contribution of each explanatory variable. In the example illustrated in FIG. 28, the ratios when the prediction target is “coffee” (refer to FIG. 28(a)) and the ratios when the prediction target is “500 ml plastic bottle” (refer to FIG. 28(b)) are represented as pie charts. Displaying the ratios in this manner makes it possible to visually grasp a degree of influence of a factor that can contribute to the prediction target while making comparisons with other explanatory variables.

Furthermore, in the invention of the present application, since the degrees of contribution are aggregated by summarizing the prediction models (prediction formulas) provided for each prediction target, it is possible to implement the display by development and consolidation in both of a direction of the category of the explanatory variable and a direction of the classification of the prediction target.

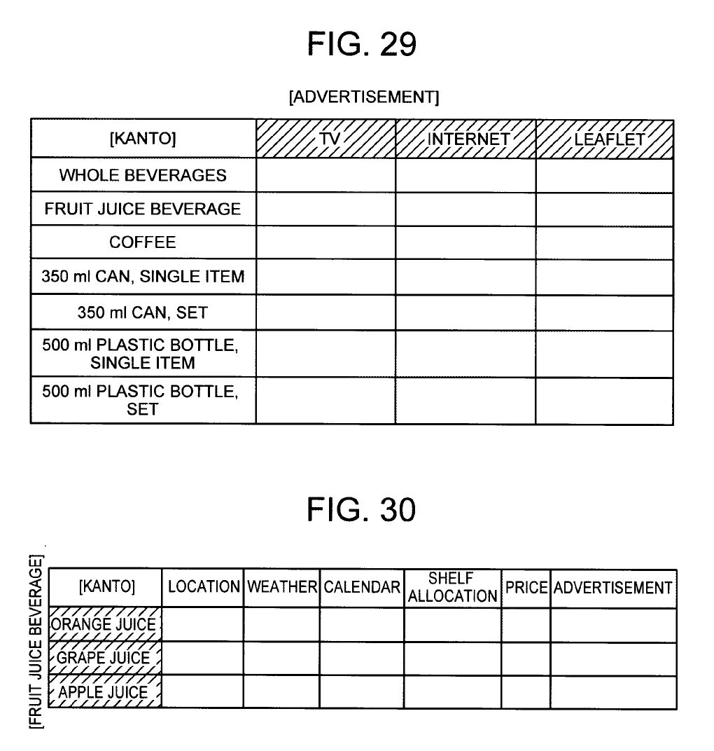

FIG. 29 is an explanatory diagram illustrating an example of outputting the degrees of contribution of explanatory variables belonging to a category. For example, when a category is selected from the table exemplified in FIG. 25 by a screen operation or the like, the output unit 40 may output the degree of contribution for each explanatory variable included in the selected category. The example illustrated in FIG. 29 indicates that, when the category “advertisement” is selected from the table exemplified in FIG. 25, the aggregating unit 20 calculates the degrees of contribution of the explanatory variables belonging to category “advertisement”, namely, “TV advertisement”, “Internet posting”, and “leaflet distribution” and the output unit 40 outputs the aggregation results thereof.

FIG. 30 is an explanatory diagram illustrating an example in which prediction targets are changed. For example, when a prediction target is selected from the table exemplified in FIG. 25 by a screen operation or the like, the output unit 40 may output the degree of contribution of a prediction formula included in the selected prediction target. The example illustrated in FIG. 30 indicates that, when the prediction target “fruit juice beverage” is selected from the table exemplified in FIG. 25, the aggregating unit 20 calculates, for each category, the degrees of contribution of “orange juice”, “grape juice”, and “apple juice” which are the prediction targets included in the prediction target “fruit juice beverage” and the output unit 40 outputs the aggregation results thereof.

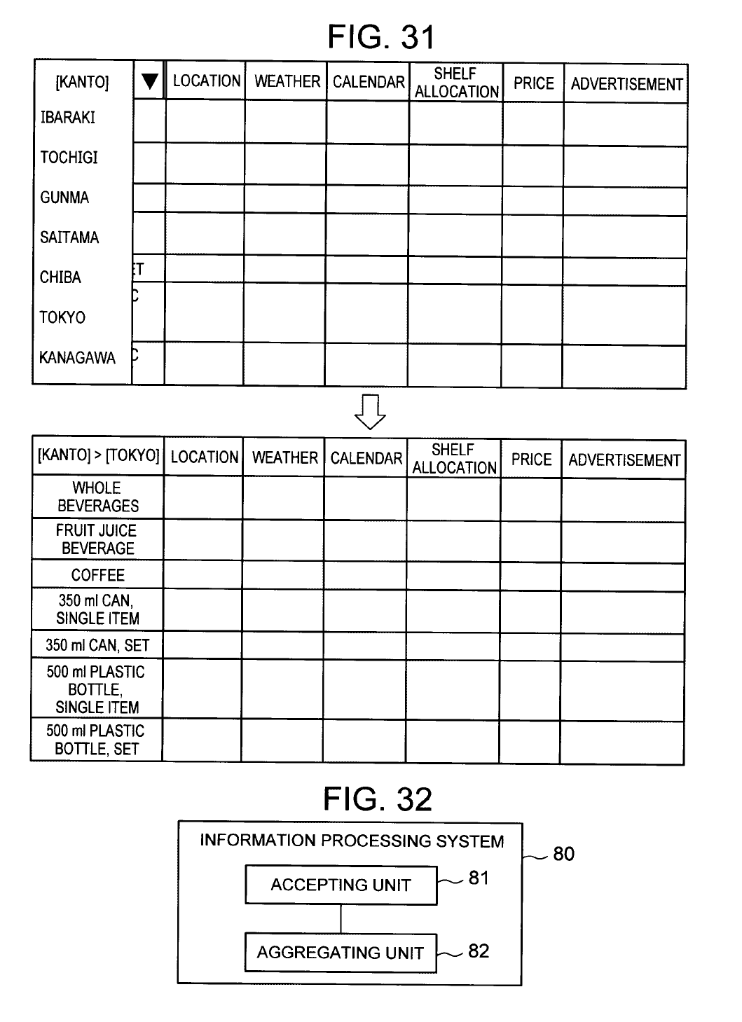

FIG. 31 is an explanatory diagram illustrating another example in which prediction targets are changed. The example illustrated in FIG. 31 indicates an example in which Tokyo is selected from the Kanto as a prediction target. As exemplified in FIG. 31, the output unit 40 may display a classification that can specify a prediction target in a selectable manner. Note that the hierarchy of the prediction target is not limited to one level and a plurality of hierarchies may be employed. For example, selection of a store (for example, “shop A”) as a lower hierarchy of Tokyo may be enabled.

In addition, the examples illustrated in FIGS. 29 to 31 have exemplified the case of selecting the target for which the degree of contribution is displayed by drill-down, but the change of the output contents is not limited to the case of designation by drill-down. When another range of prediction targets (or classifications of prediction targets) is designated according to an instruction from a user or the like, the aggregating unit 20 simply calculates the degrees of contribution according to the designated contents such that the output unit 40 outputs the calculation results thereof.

Note that the above-described specific examples have described a case where the sales relating to the commodity are treated as prediction targets. However, a case where a target relating to the service is assigned as a prediction target can be similarly handled. For example, the number of visitors to a facility providing a certain service can be cited as a prediction target relating to the service.

In addition, the above-described specific examples have exemplified the contents and properties of the commodity and the place where the commodity is provided as the classifications of the prediction target, but the classifications of the prediction target are not limited to these contents. For example, the classification may be provided from the viewpoint of a seller or purchaser, or may be provided from the viewpoint of the time the commodity is provided. Furthermore, such a classification is not limited to a case where the prediction target is a target relating to the commodity and can be adopted similarly also in a case where the prediction target is a target relating to the service.

For example, it is assumed that a factor of the number of visitors to a facility F providing a certain service is analyzed. In this case, it is conceivable to set the timing (March 2015) as the classification. In addition, an advertisement (for example, the number of times of broadcasting a commercial in the Kansai region, in which talent A has been appointed, and the number of times of appearing in an advertisement hanging inside a predetermined train) may be used as a factor (explanatory variable).

Besides, for example, it is assumed that a factor of a certain lifestyle disease is analyzed. At this time, for example, age (40 generations), gender (male), and the like can be cited as classifications.

In addition, from such a viewpoint, the information processing system of the invention of the present application can be used not only for sales predictions at retail stores, but also for a wide range of industries and prediction targets such as production predictions for manufacturing industries, predictions of the number of passengers for railway companies, and demand predictions for electric utilities.

Next, the outline of the present invention will be described. FIG. 32 is a block diagram illustrating the outline of the information processing system according to the present invention. An information processing system 80 according to the present invention is an information processing system (for example, the information processing system 100) configured to predict a prediction target specified by a plurality of classifications using a prediction model including a variable that affects the prediction target, the information processing system including: an accepting unit 81 (for example, the accepting unit 10) that accepts classifications that specify the prediction target; and an aggregating unit 82 (for example, aggregating unit 20) that specifies the prediction target by the accepted classifications and aggregates, for each variable (for example, each explanatory variable), the degree of contribution determined by the prediction model corresponding to the prediction target.

With such a configuration, a factor that can contribute to the prediction target can be analyzed.

In addition, the information processing system 80 may further include a storage unit (for example, the storage unit 30) that stores a prediction target specified by a plurality of classifications in association with a prediction model including a variable that affects the prediction target. Then, the aggregating unit 82 may aggregate for the prediction target specified by the accepted classifications among a plurality of prediction targets stored in the storage unit.

In addition, the aggregating unit 82 may aggregate the degree of contribution (for example, the third degree of contribution) for each of categories based on a correspondence relationship between a variable and one of the categories to which this variable belongs. With such a configuration, analysis from a more global viewpoint is enabled.

Specifically, the aggregating unit 82 may aggregate a weight of the variable as the degree of contribution. In addition, the aggregating unit 82 may calculate, for each variable, a total sum of the weights of the variable included in prediction models for specified prediction targets as a first degree of contribution. With such a configuration, it is possible to analyze a contributable factor (explanatory variable) by summarizing a plurality of prediction targets.

In addition, the prediction model may be represented by a linear regression equation including a plurality of variables. At this time, the aggregating unit 82 may aggregate coefficients of the variables included in the prediction model as the weights of these variables.

In addition, when the prediction model is represented by a linear regression equation including a plurality of variables, the aggregating unit 82 may calculate products of coefficients of the variables included in the prediction model and actually measured values of these variables for each of the variables and calculate a total sum of the calculated products for each of the variables as a second degree of contribution. With such a configuration, analysis that reflects a performance value is enabled.

At that time, the aggregating unit 82 may correct the degree of contribution based on an error which is a difference between a predicted value and an actually measured value of the prediction target. In addition, the aggregating unit 82 may aggregate an error which is a difference between a predicted value and an actually measured value of the prediction target as the degree of contribution of a variable indicating this error.

In addition, the aggregating unit 82 may standardize the degrees of contribution calculated for each variable. For example, in the case of the example illustrated in FIG. 7, the aggregating unit 82 may standardize (standardize in the horizontal direction) the degrees of contribution w₁ to w₄ calculated for each explanatory variable.

In addition, the aggregating unit 82 may calculate a ratio of the degree of contribution of a variable to a calculated total sum of the degrees of contribution of variables for each of these variables. For example, in the case of the example illustrated in FIG. 7, the aggregating unit 82 may calculate the total sum of the degrees of contribution w₁ to w₄ calculated for each explanatory variable and calculate the ratio (ratio in the horizontal direction) of the degree of contribution of each explanatory variable to that total sum.

Meanwhile, the aggregating unit 82 may standardize weights of a variable common to respective prediction formulas for each variable. For example, in the case of the example illustrated in FIG. 7, the aggregating unit 82 may standardize (standardize in the vertical direction) the coefficients a₁₁ and a₃₁ of the explanatory variable x₁ included in the prediction formula as a target.

In addition, the aggregating unit 82 may calculate a ratio of a weight of a common variable to a total sum of weights of the variable for each prediction target. For example, in the case of the example illustrated in FIG. 7, the aggregating unit 82 may calculate the ratio (ratio in the vertical direction) of the weight of the explanatory variable x₁ in each prediction formula (a₁₁/a₁₁+a₃₁, a₃₁/aᵢᵢ+a₃₁) to the total sum of the weight of the explanatory variable x₁ (a₁₁+a₃₁).

In addition, the aggregating unit 82 may calculate the degree of contribution for each variable using a prediction model (for example, the conditional predictor) in which a prediction formula is specified according to a value of a variable (for example, a sample) to be applied.

Note that the prediction target may be a target relating to a commodity or a service. Additionally, the classification may be information indicating any one of contents or properties of the commodity or the service, a seller or a purchaser of the commodity or the service, and a place or time at which the commodity or the service is provided.

In addition, the information processing system may include an output unit (for example, the output unit 40) that displays a result of aggregation for a directly controllable variable (for example, “advertisement”, “price”, and “shelf allocation” exemplified in FIG. 27) and a result of aggregation for a variable not directly controllable (for example, “location”, “weather”, and “calendar” exemplified in FIG. 27) in a form distinguishable from each other (in the example illustrated in FIG. 27, the categories are displayed with the black frames).

In addition, a case where the prediction model is a linear regression equation has been described thus far. However, the prediction model is not limited to the linear regression equation. The present invention can be applied as long as the prediction model is made up of a variable that affects the prediction target and the degree of contribution to the prediction target is determined by the prediction model.

### REFERENCE SIGNS LIST

10 Accepting unit
20 Aggregating unit
30 Storage unit
40 Output unit
100 Information processing system

1. An information processing system configured to predict a prediction target specified by a plurality of classifications using a prediction model including a variable that affects the prediction target, the information processing system comprising:
a hardware including a processor;
an accepting unit, implemented by the processor, that accepts the classifications that specify the prediction target; and
an aggregating unit, implemented by the processor, that specifies the prediction target by the accepted classifications and aggregates, for each of the variables, a degree of contribution determined by the prediction model corresponding to the prediction target.

2. The information processing system according to claim 1, further comprising a storage unit that stores a prediction target specified by a plurality of classifications in association with a prediction model including a variable that affects the prediction target, wherein
the aggregating unit aggregates for the prediction target specified by the accepted classifications among a plurality of prediction targets stored in the storage unit.

3. The information processing system according to claim 1, wherein
the aggregating unit aggregates the degree of contribution for each of categories based on a correspondence relationship between a variable and one of the categories to which the variable belongs.

4. The information processing system according to claim 1, wherein
the aggregating unit aggregates a weight of the variable as the degree of contribution.

5. The information processing system according to claim 4, wherein
the aggregating unit calculates, for each variable, a total sum of the weights of the variable included in prediction models for specified prediction targets as a first degree of contribution.

6. The information processing system according to claim 4, wherein
the prediction model is represented by a linear regression equation including a plurality of variables, and
the aggregating unit aggregates coefficients of the variables included in the prediction model as the weights of the variables.

7. The information processing system according to claim 4, wherein
the prediction model is represented by a linear regression equation including a plurality of variables, and
the aggregating unit calculates products of coefficients of the variables included in the prediction model and actually measured values of the variables for each of the variables and calculates a total sum of the calculated products for each of the variables as a second degree of contribution.

8. The information processing system according to claim 7, wherein
the aggregating unit corrects the degree of contribution based on an error which is a difference between a predicted value and an actually measured value of the prediction target.

9. The information processing system according to claim 7, wherein
the aggregating unit aggregates an error which is a difference between a predicted value and an actually measured value of the prediction target as the degree of contribution of a variable indicating the error.

10. The information processing system according to claim 1, wherein
the aggregating unit standardizes the degrees of contribution calculated for each variable.

11. The information processing system according to claim 1, wherein
the aggregating unit calculates a ratio of the degree of contribution of a variable to a calculated total sum of the degrees of contribution of variables for each of the variables.

12. The information processing system according to claim 1, wherein
the aggregating unit standardizes weights of a variable common to respective prediction formulas for each variable.

13. The information processing system according to claim 1, wherein
the aggregating unit calculates a ratio of a weight of a common variable to a total sum of weights of the variable for each prediction target.

14. The information processing system according to claim 1, wherein
the aggregating unit calculates the degree of contribution for each variable using a prediction model in which a prediction formula is specified according to a value of a variable to be applied.

15. The information processing system according to claim 1, wherein
the prediction target is a target relating to a commodity or a service, and
the classification is information indicating any one of contents or properties of the commodity or the service, a seller or a purchaser of the commodity or the service, and a place or time at which the commodity or the service is provided.

16. The information processing system according to claim 1, comprising an output unit, implemented by the processor, that displays a result of aggregation for a directly controllable variable and a result of aggregation for a variable not directly controllable in a form distinguishable from each other.

17. An information processing method configured to predict a prediction target specified by a plurality of classifications using a prediction model including a variable that affects the prediction target, the information processing method comprising:
accepting the classifications that specify a prediction target; and
specifying the prediction target by the accepted classifications and aggregating, for each of the variables, a degree of contribution determined by the prediction model corresponding to the prediction target.

18. The information processing method according to claim 17, comprising:
aggregating for the prediction target specified by the accepted classifications, among a plurality of prediction targets stored in a storage unit that stores a prediction target specified by a plurality of classifications in association with a prediction model including a variable that affects the prediction target.

19. A non-transitory computer readable information recording medium storing an information processing program applied to a computer configured to predict a prediction target specified by a plurality of classifications using a prediction model including a variable that affects the prediction target, when executed by a processor, the information processing program performs a method for:
accepting the classifications that specify the prediction target; and
specifying the prediction target by the accepted classifications and aggregating, for each of the variables, a degree of contribution determined by the prediction model corresponding to the prediction target.

20. The non-transitory computer readable information recording medium according to claim 19, aggregating for the prediction target specified by the accepted classifications, among a plurality of prediction targets stored in a storage unit that stores a prediction target specified by a plurality of classifications in association with a prediction model including a variable that affects the prediction target.
